(19) United States
(12) Patent Application Publication
(10) Pub. No.: US 2008/0123117 A1
(43) Pub. Date: May 29, 2008

(54) Image Processing Method, Computer-Readable Program, Image Processing Apparatus, Image Forming Apparatus and Image Forming System

(76) Inventors: Takashi Kimura, Kanagawa (JP); Masakazu Yoshida, Kanagawa (JP); Shino Sasaki, Kanagawa (JP)

Correspondence Address: COOPER & DUNHAM, LLP, 1185 AVENUE OF THE AMERICAS, NEW YORK, NY, 10036, US

(21) Appl. No.: 11/794,383

(22) PCT Filed: Oct. 30, 2006
(86) PCT No.: PCT/JP06/22060

§ 371 Date: Jun. 27, 2007

(30) Foreign Application Priority Data
Nov. 4, 2005 (JP) 2005-321550
Nov. 4, 2005 (JP) 2005-321621

(51) Int. Cl. G06F 15/00

(52) U.S. Cl. 358/1.8; 358/1.9

(57) ABSTRACT

An image processing method generates image data for use by an image forming apparatus which forms an image on a recording medium by ink dots formed by ejected ink drops. The image processing method includes the steps of judging an image portion and a background portion of the image, and adding image dots to the background portion adjacent to the image portion to fatten the image portion by a fattening process, depending on at least one of a character size of the image portion, a character type of the image portion, a resolution of the image portion, and a color of the background portion.

### TECHNICAL FIELD

The present invention generally relates to image processing methods, computer-readable programs, image processing apparatuses, image forming apparatuses and image forming systems, and more particularly to an image processing method, an image processing apparatus, an image forming apparatus and an image forming system that are suited for ink-jet recording (or printing), and to a computer-readable program which causes a computer to carry out such an image processing method.

### BACKGROUND ART

As image forming apparatuses such as printers, facsimile apparatuses, copying apparatuses and multi-function peripherals (or composite apparatuses) having the functions of the printer, facsimile apparatus and copying apparatus, there are the so-called ink-jet recording apparatuses which use an ink-jet recording head, for example. The ink-jet recording apparatus makes an image formation on a recording medium by ejecting ink from the ink-jet recording head onto the recording medium. The recording medium may be paper, OHP film or any suitable recording sheet onto which the ink other liquids may be adhered. The image formation includes various kinds of recording and printing of characters, images and/or photographs.

In the ink-jet recording apparatuses may be categorized into a serial type and a line type. The serial type ink-jet recording apparatus moves a carriage which is mounted with the recording head in a main scanning direction, and forms the image on the recording medium that is intermittently transported in a direction perpendicular to the main scanning direction. The line type ink-jet recording apparatus has a line type recording head that is provided with a plurality of nozzles arranged in a line, and forms the image on the recording medium that is transported in a direction perpendicular to a direction in which the nozzles of the line type recording head are arranged.

Regardless of whether the ink-jet recording apparatus is the serial type or the line type, the image is formed on the recording medium by arranging dots in a matrix arrangement, namely, in the main scanning direction (or the direction in which the nozzles of the line type recording head are arranged) and the direction in which the recording medium is transported.

For this reason, particularly when recording a character image on the recording medium, the dots at an oblique line portion of the character increase or decrease in steps according to the resolution. Consequently, the dots appear jaggy to the human eyes, and it may not be possible to obtain a sufficiently high picture quality.

In addition, the ink-jet recording employs the ink which is a liquid. Particularly when the image is recorded on plain paper, picture quality deteriorations peculiar to the ink-jet recording, such as color reproducibility of the image, durability of the image, light resistance of the image, ink drying characteristic (fixing characteristic), feathering of characters, and color bleeding at color boundaries, become conspicuous. Moreover, when an attempt is made to carry out a high-speed recording with respect to the plain paper, it is extremely difficult to carry out the recording while satisfying all of these characteristics which affect the picture quality.

With respect to the picture quality deterioration caused by the jaggy described above, a Japanese Laid-Open Utility Model Application No. 03-113452 proposes a smoothing method called anti-aliasing, which smoothens contours of jaggy character images.

However, according to this proposed smoothing method, the contour is smoothened by changing dots in an extremely large number of gradation levels. For this reason, although a highly accurate smoothing can be realized, the smoothing process is extremely complex and requires a long processing time. As a result, this proposed smoothing method is unsuited for application to image forming apparatuses that require a high throughput, such as the recent ink-jet recording apparatuses.

With regard to the picture quality deterioration caused by the feathering when forming the image on the plain paper, a pigment-based ink using an organic pigment, carbon black or the like as the coloring agent may be used for the recording on the plain paper, in place of using the dye-based ink. Unlike dye, the pigment has no solubility to water. Hence, the pigment is normally mixed with a dispersing agent and subjected to a dispersion process to form a water ink in which the pigment is stably dispersed in water.

However, since the pigment-based ink also includes water, it is impossible to completely eliminate the feathering when recording on the plain paper.

When creating a document using an application software, there are situations where a character is emphasized by using a character which is in white (or a color close to white) with respect to a background that is black (or another color other than white or the character color). Such a character will hereinafter be referred to as a white character. The white character is a reverse character of a character which is in black (or another color other than white or the background color) with respect to the background that is white (or a color close to white).

When recording the white character on the ink-jet recording apparatus using the ink, the ink bleeds, causing the ink of the black portion to bleed into the white character portion. As a result, the white character may become thin or, a portion of the white character may be deformed. Particularly in a case where the character is small or, the character is thin such as a Mincho typeface, the tendency is for the deformation of the character to become more conspicuous.

A similar problem also occurs when emphasizing a character by using a character which is in black (or another color other than white or the background color) with respect to a background that is white (or a color close to white). Such a character will hereinafter be referred to as a black character. The black character is a reverse character of the white character.

### DISCLOSURE OF THE INVENTION

It is a general object of the present invention to provide an image forming method, computer-readable program, image processing apparatus, image forming apparatus and image forming system, in which the problems described above are suppressed.

A more specific object of the present invention is to provide an image forming method, computer-readable program, image processing apparatus, image forming apparatus and image forming system, which can improve the quality of the white character or the black character.

Still another object of the present invention is to provide an image processing method for generating image data for use by an image forming apparatus which forms an image on a recording medium by ink dots formed by ejected ink drops, comprising judging an image portion and a background portion of the image; and adding image dots to the background portion adjacent to the image portion to fatten the image portion by a fattening process, depending on at least one of a character size of the image portion, a character type of the image portion, a resolution of the image portion, and a color of the background portion.

A further object of the present invention is to provide an image processing apparatus comprising a control part configured to generate the image data according to the image processing method described above.

Another object of the present invention is to provide an image forming apparatus comprising a part configured to receive image data from the image processing apparatus described above; and a recording head configured to eject ink drops onto a recording medium to form an image thereon in response to the image data.

Still another object of the present invention is to provide an image forming apparatus-comprising a recording head configured eject ink drops onto a recording medium to form an image thereon in response to image data; and a control part configured to generate the image data, wherein the control part comprises a part configured to judge an image portion and a background portion of the image; and a part configured to add image dots to the background portion adjacent to the image portion to fatten the image portion by a fattening process only during a predetermined mode.

A further object of the present invention is to provide a computer-readable program for causing a computer to generate image data for use by an image forming apparatus which forms an image on a recording medium by ink dots formed by ejected ink drops, comprising a procedure causing the computer to judge an image portion and a background portion of the image; and a procedure causing the computer to add image dots to the background portion adjacent to the image portion to fatten the image portion by a fattening process, depending on at least one of a character size of the image portion, a character type of the image portion, a resolution of the image portion, and a color of the background portion.

Other objects and further features of the present invention will be apparent from the following detailed description when read in conjunction with the accompanying drawings.

### BRIEF DESCRIPTION OF THE DRAWINGS

FIG. 1 is a side view, in partial cross section, showing a structure of a mechanism part of an image forming apparatus which outputs image data generated by an image processing method in a first embodiment of the present invention;

FIG. 2 is a plan view showing an important part of the mechanism part of the image forming apparatus shown in FIG. 1;

FIG. 3 is a cross sectional view of a recording head of the image forming apparatus shown in FIG. 1 taken along a longitudinal direction of an ink chamber;

FIG. 4 is a cross sectional view of the recording head of the image forming apparatus shown in FIG. 1 taken in a direction along a shorter side of the ink chamber;

FIG. 5 is a system block diagram generally showing a control part of the image forming apparatus shown in FIG. 1;

FIG. 6 is a system block diagram showing a print control part of the control part shown in FIG. 5;

FIG. 7 is a diagram showing a driving signal waveform generated by a driving waveform generator of the print control part shown in FIG. 6;

FIG. 8 is a timing chart for explaining driving signals selected from the driving signal waveform to realize a small ink drop, a medium ink drop, a large ink drop and a micro drive;

FIG. 9 is a diagram for explaining a driving signal waveform depending on an ink viscosity;

FIG. 10 is a system block diagram showing an image forming system in the first embodiment of the present invention;

FIG. 11 is a system block diagram showing the image processing apparatus in the image forming system shown in FIG. 10;

FIG. 12 is a diagram showing a white character that is formed by a comparison example;

FIG. 13 is a diagram showing dots of an important part on an enlarged scale, for explaining the white character that is formed by the comparison example;

FIG. 14 is a diagram showing a white character that is formed by carrying out a character fattening process in the first embodiment of the present invention;

FIG. 15 is a diagram showing dots of an important part on an enlarged scale, for explaining the white character that is formed by carrying out the character fattening process;

FIG. 16 is a diagram showing dots of an important part on an enlarged scale, for explaining a white character that is formed by another character fattening process in the first embodiment of the present invention;

FIG. 17 is a diagram for explaining a window size used for a pattern matching;

FIG. 18 is a diagram for explaining a 3×3 window size;

FIG. 19 is a flow chart for explaining the character fattening process;

FIGS. 20A through 20C are diagrams for explaining reference patterns of the 3×3 window size used in the character fattening process;

FIGS. 21A and 21B are diagrams for explaining the use of the reference patterns shown in FIGS. 20A through 20C;

FIGS. 22A through 22D are diagrams for explaining reference patterns of the 5×5 window size used in the character fattening process;

FIGS. 23A and 23B are diagrams for explaining the use of the reference patterns shown in FIGS. 22A through 22D;

FIG. 24 is a diagram showing evaluation results with and without character fattening process;

FIG. 25 is a flow chart for explaining a process of switching between a mode that carries out the character fattening process depending on the character size, character type and resolution, and a mode that does not carry out the character fattening process;

FIGS. 26A and 26B respectively are a perspective view and a cross sectional view for explaining another structure of the recording head;

FIG. 27 is a cross sectional view for explaining still another structure of the recording head;

FIG. 28 is a diagram showing a black character that is formed by a comparison example;

FIG. 29 is a diagram showing dots of an important part on an enlarged scale, for explaining the black character that is formed by the comparison example;

FIG. 30 is a diagram showing a black character that is formed by carrying out a character fattening process in the second embodiment of the present invention;

FIG. 31 is a diagram showing dots of an important part on an enlarged scale, for explaining the black character that is formed by carrying out the character fattening process;

FIG. 32 is a diagram for explaining a window size used for a pattern matching;

FIG. 33 is a diagram for explaining a 3×3 window size;

FIG. 34 is a flow chart for explaining the character fattening process;

FIGS. 35A through 35C are diagrams for explaining reference patterns of the 3×3 window size used in the character fattening process;

FIGS. 36A and 36B are diagrams for explaining the use of the reference patterns shown in FIGS. 35A through 35C;

FIG. 37 is a flow chart for explaining another character fattening process;

FIGS. 38A through 38E are diagrams for explaining reference patterns of the 9×3 window size used in the character fattening process;

FIGS. 39A and 39B are diagrams for explaining the use of the reference patterns shown in FIGS. 35A through 35C;

FIG. 40 is a diagram for explaining a character fattening process using a first jaggy correction;

FIG. 41 is a diagram for explaining a character fattening process using a second jaggy correction;

FIG. 42 is a diagram for explaining a character fattening process using a third jaggy correction;

FIG. 43 is a diagram for explaining a character fattening process using a fourth jaggy correction;

FIG. 44 is a diagram for explaining a character fattening process using a fifth jaggy correction;

FIG. 45 is a diagram for explaining a character fattening process using a sixth jaggy correction;

FIG. 46 is a diagram for explaining a character fattening process using a seventh jaggy correction;

FIG. 47 is a diagram for explaining a character fattening process using an eighth jaggy correction;

FIG. 48 is a flow chart for explaining the character fattening processes using the fifth through eighth jaggy corrections;

FIG. 49 is a diagram showing evaluation results with and without character fattening process;

FIG. 50 is a flow chart for explaining a process of switching between a mode that carries out the character fattening process depending on the character size, character type and resolution, and a mode that does not carry out the character fattening process; and

FIGS. 51A and 51B are diagrams for explaining the jaggy correction with and without the character fattening process.

### BEST MODE FOR CARRYING OUT THE INVENTION

### First Embodiment

In a first embodiment of the present invention, if an image to be formed on a recording medium includes a white character which is in white or a color close to white, a fattening process is carried out to fatten the white character by adding blank dots to a background portion that is adjacent to dots forming the white character.

The white character is in white or a color close to white, and may be the color of the recording medium itself or, the color that is formed on the recording medium as a base color. In addition, the adding of the blank dots to the background portion includes replacing the dots of the background portion by the blank dots.

Dots in a periphery of the character may be in two or more colors.

It is preferable to judge whether or not a dot is to be added with the blank dot based on a pattern matching between an m×n window which includes a target pixel and a predetermined pattern. In this case, the pattern matching is preferably applied to the background portion of the image, and the blank dot is added depending on a result of the pattern matching.

Furthermore, it is preferable that a selection or switching may be made between a mode which adds the blank dots and a mode which does not add the blank dots. The selection or switching between the two modes may be made depending on the character size, the color of the dots in the periphery of the character, the kind of character and the resolution of the image.

According to this embodiment, it is possible to prevent the bleeding from the background portion that would otherwise thin the white character, and thus improve the picture quality of the white character.

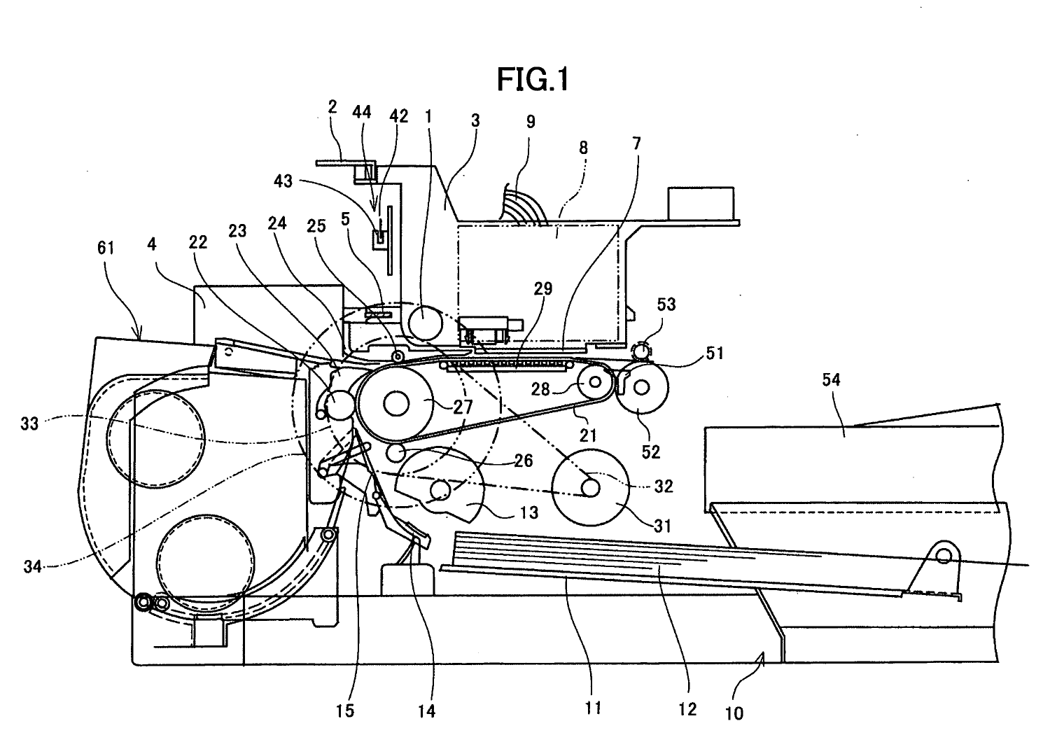

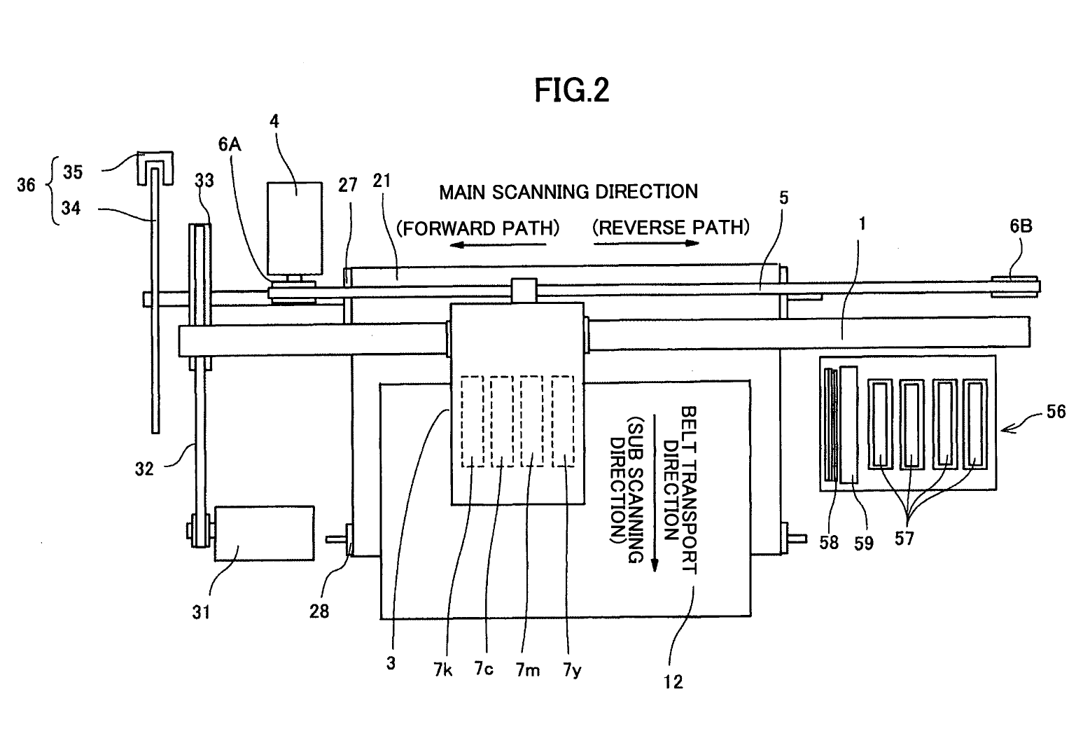

A description will now be given of this first embodiment of the present invention. First, a description will be given of an image forming apparatus which outputs image data generated by an image processing method in this first embodiment of the present invention, by referring to FIGS. 1 and 2. FIG. 1 is a side view, in partial cross section, showing a structure of a mechanism part of the image forming apparatus which outputs the image data generated by the image processing method in this first embodiment of the present invention, and FIG. 2 is a plan view showing an important part of the mechanism part of the image forming apparatus shown in FIG. 1.

The image forming apparatus shown in FIG. 1 has a guide rod 1 and a guide rail 2, which form guide members provided between right and left side plates (not shown), and support a carriage 3 in a manner freely slidable in a main scanning direction. The carriage 3 is driven by a main scan motor 4 via timing belt 5 which is provided between a driving pulley 6A and a following pulley 6B, so as to scan in the main scanning direction which is indicated by arrows in FIG. 2.

Four recording heads 7y, 7c, 7m and 7k, formed by corresponding ink-jet heads that respectively eject yellow (Y), cyan (C), magenta (M) and black (K) inks, are provided on the carriage 3 with a plurality of ink ejection nozzles thereof arranged in a direction perpendicular to the main scanning direction. The ink ejection nozzles of the recording heads 7y, 7c, 7m and 7k face down in FIG. 1, so that the Y, C, M and K inks are ejected downwards in FIG. 1. Since the recording heads 7y, 7c, 7m and 7k basically have the same structure, a description will hereinafter be given with respect to a recording head 7 when not referring to a specific color of the ink.

A pressure generating means of the ink-jet head forming the recording head 7 is made up of a piezoelectric actuator such as a piezoelectric element, a thermal actuator which uses an electro-thermal conversion element such as a heating resistor that utilizes a phase change caused by film boiling of the ink, a shape memory alloy actuator that utilizes a metal phase change caused by a temperature change or, an electrostatic actuator that utilizes an electrostatic force, and generates a pressure that is required to eject the ink from the ink ejection nozzle. Of course, it is not essential to provide an independent recording head 7 for each ink color, and the four recording heads 7 may be formed by one or a plurality of ink-jet heads each having a nozzle row that is made up of a plurality of ink ejection nozzles for ejecting the inks of a plurality of colors.

A sub-tank 8 is mounted on the carriage 3 with respect to each of the recording heads 7 of the corresponding color. The sub-tank 8 is connected to a main tank (or an ink cartridge, not shown) via an ink supply tube 9, and receives the supply of the ink of the corresponding color from the main tank.

On the other hand, recording media 12, such as paper and film, are stacked on a spring-loaded media stacking part 11 of a media supply cassette 10 or the like, and are supplied by a media supply part. The media supply part includes a cresentic roller (or medium supply roller) 13 which separates and supplies the recording media 12, one by one, from the media stacking part 11, and a separation pad 14 which confronts the medium supply roller 13 and is made of a material having a large coefficient of friction. The separation pad 14 is urged towards the medium supply roller 13.

The recording medium 12 supplied from the media supply part is transported under the recording heads 7. In order to realize such a transport of the recording medium 12, a transport belt 21, a counter roller 22, a transport guide 23, a push member 24 and a push roller 25 are provided. The transport belt 21 transports the recording medium 12 that is electrostatically adhered thereon. The counter roller 22 is provided to transport the recording medium 12 which is supplied from the media supply part via a guide 15, between the counter roller 22 and the transport belt 21. The transport guide 23 guides the recording medium 12 which is supplied approximately in the vertical direction (upward direction) in FIG. 1 to turn by approximately 90 degrees in a direction along the transport belt 21. The push member 24 urges the push roller 25 towards the transport belt 21. Moreover, a charging roller 26 is provided as a charging means for charging a top (or outer) surface of the transport belt 21.

The transport belt 21 is formed by an endless belt that is provided across a transport roller 27 and a tension roller 28. A sub scan motor 31 rotates the transport roller 27 via a timing belt 32 and a timing roller 33, so as to circulate the transport belt 21 in a belt transport direction (or sub scanning direction) indicated by an arrow in FIG. 2. A guide member 29 is provided on a back (or inner) surface side of the transport belt 21, at a position corresponding to an image forming region of the recording heads 7. The charging roller 26 is arranged at a position to contact the top surface of the transport belt 21 and rotates to follow the circulation movement of the transport belt 21.

As shown in FIG. 2, a slit disk 34 is mounted on a shaft of the transport roller 27, and a sensor 35 is provided to detect one or a plurality of slits in the slit disk 34. The slit disk 34 and the sensor 35 form a rotary encoder 36.

Furthermore, a media eject part is provided to eject the recording medium 12 that has been subjected to the recording by the recording head 7. The media eject part includes a separation claw 51 for separating the recording medium 12 from the transport belt 21, a media eject rollers 52 and 53, and a media eject tray 54 on which the ejected recording media 12 are stacked.

A duplex media supply unit 61 is detachably provided on a rear part of the image forming apparatus. The duplex media supply unit 61 reverses (or turns over) the recording medium 12 that is fed back by a reverse circulation movement of the transport belt 21, and supplies the reversed recording medium 12 again between the counter roller 22 and the transport belt 21.

As shown in FIG. 2, a recovery mechanism 56 is arranged at a position corresponding to a non-recording region on one side (right side in FIG. 2) along the main scanning direction of the carriage 3. The recovery mechanism 56 recovers and maintains the ink-jet nozzles of the recording heads 7 in a recordable state.

The recovery mechanism 56 includes caps 57 for capping each of the nozzle surfaces of the recording heads 7, a wiper blade 58 for wiping the nozzle surfaces of the recording heads 7, and an ink receiving part 59 for receiving the inks ejected from the nozzles of the recording heads 7 when a blank ink ejection is made to remove the inks having the increased viscosity and prevent the normal ink ejection from the nozzles from being interfered by the inks having the increased viscosity.

In the image forming apparatus having the structure described above, the recording media 12 are separated and supplied one by one from the media supply part, and the supplied recording medium 12 is guided approximately vertically in FIG. 1 by the guide 15. The recording medium 12 is then transported between the transport belt 21 and the counter roller 22, and the tip end of the recording medium 12 is guided by the transport guide 23. The recording medium 12 is pushed against the transport belt 21 by the push roller 25, so that the transport direction of the recording medium 12 is changed by approximately 90 degrees.

In this state, an A.C. voltage which alternately repeats a positive polarity and a negative polarity is applied from an A.C. bias supply part (not shown) to the charging roller 26 under a control of a control part (not shown) which will be described later. The control part, including the A.C. bias supply part, will be described later. As a result, the top surface of the transport belt 21 is charged by the alternating charging voltage pattern, that is, a pattern in which the positive polarity and the negative polarity are alternately repeated at predetermined widths in the circulating direction of the transport belt 21 (sub scanning direction). When the recording medium 12 is supplied onto the charged transport belt 21, the recording medium 12 is adhered on the transport belt 21 by electrostatic force. The recording medium 12 adhered on the transport belt 21 is transported in the sub scanning direction by the circulation movement of the transport belt 21.

By driving the recording heads 7 depending on an image signal while moving the carriage 3 in forward and reverse paths (going and returning paths) along the main scanning direction, the ink drops are ejected on the stationary recording medium 12 to record one line. The recording medium 12 is then transported by a predetermined amount in the sub scanning direction to record the next line. When a recording end signal or a rear end of the recording medium 12 is detected, the recording operation ends, and the recorded recording medium 12 is ejected onto the media eject tray 54.

In the case of a duplex recording which records images on both sides of the recording medium 12, the transport belt 21 is circulated in the reverse direction when the recording on the one side of the recording medium 12 (the side of the recording medium 12 that is recorded first) ends. The recording medium 12 bearing the recorded image on one side thereof is fed back to the duplex media supply unit 61, and is reversed (or turned over) so as to record the image on the other side of the recording medium 12 (the side of the recording medium 12 that is recorded second). The reversed recording medium 12 is again supplied between the counter roller 22 and the transport belt 21, and a timing control is carried out to transport the recording medium 12 similarly as described above and to record the image on the other side of the recording medium 12. The recording medium 12 bearing the images on both sides thereof is ejected onto the media eject tray 54.

In a recording standby state, the carriage 3 is moved towards the recovery mechanism 55, and the nozzle surfaces of the recording heads 7 are capped by the caps 57 so that the nozzles are maintained in a moist or wet state and prevented from clogging due to drying of the inks. In addition, a recovery operation is made to suck the inks from the nozzles in the state where the recording heads 7 are capped by the caps 57, so as to eject the air bubbles and the inks having the increased viscosity. This recovery operation also removes the inks adhered on the nozzle surfaces of the recording heads 7 by wiping clean the nozzle surface by the wiper blade 58. The blank ink ejection which is unrelated to the actual printing operation may be carried out before the start of the recording operation or during the recording operation, for example, so as to maintain a stable ink-jet characteristic of the recording heads 7.

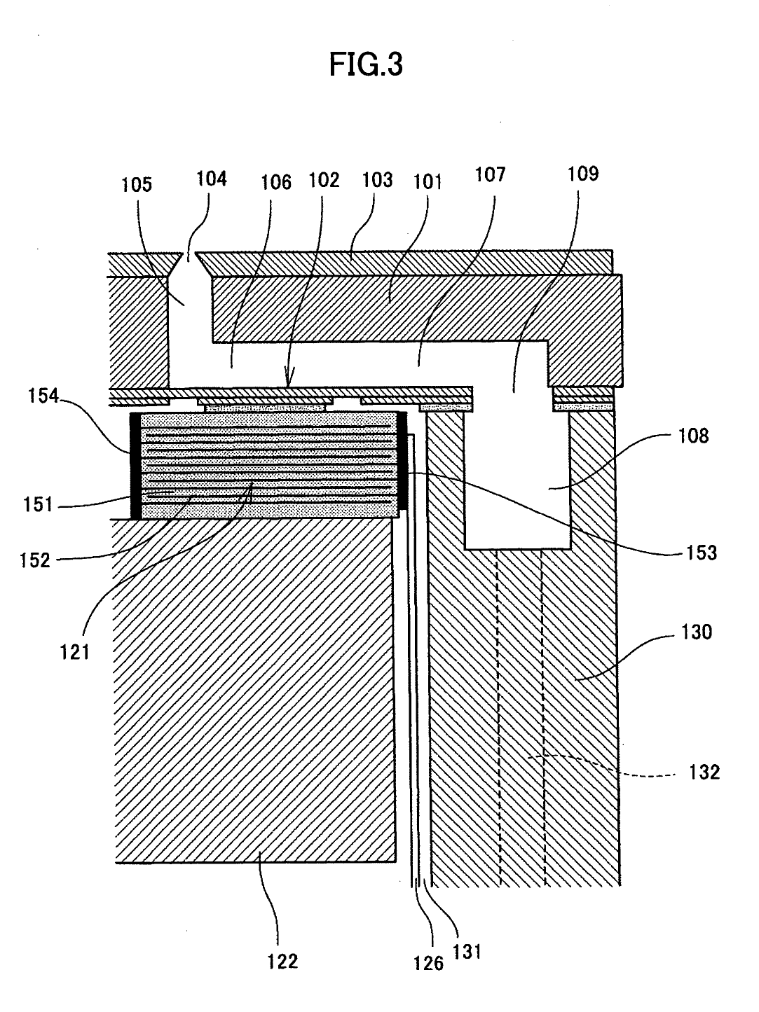

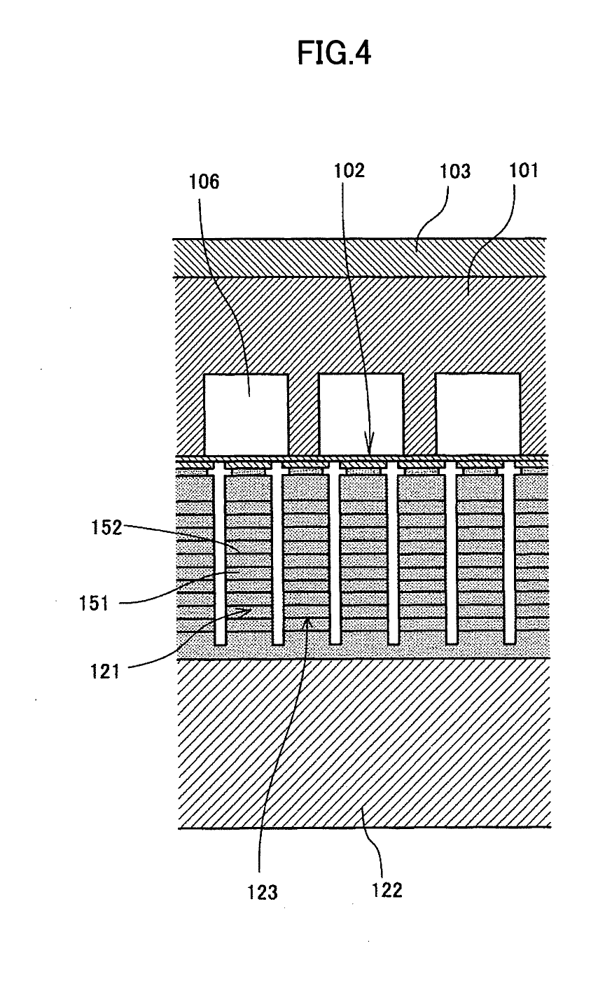

Next, a description will be given of the ink-jet head that forms the recording head 7, by referring to FIGS. 3 and 4. FIG. 3 is a cross sectional view of the recording head 7 of the image forming apparatus shown in FIG. 1 taken along a longitudinal direction of an ink chamber, and FIG. 4 is a cross sectional view of the recording head 7 of the image forming apparatus shown in FIG. 1 taken in a direction along a shorter side of the ink chamber, that is, in a direction in which the nozzles of the recording head 7 are arranged.

The ink-jet head forming the recording head 7 has a flow passage plate 101 that is formed by subjecting a single crystal silicon substrate to an anisotropic etching, for example, a vibration plate 102 that is bonded on a lower surface of the flow passage plate 101 and is formed by nickel electroforming, and a nozzle plate 103 that is bonded on an upper surface of the flow passage plate 101. A stacked structure made up of the flow passage plate 101, the vibration plate 102 and the nozzle plate 103 forms a nozzle communication passage 105 that communicates to a nozzle 104 for ejecting the ink, an ink chamber 106 in which the pressure is generated, a common ink chamber 108 for supplying the ink to the ink chamber 106 via a flow resistance part (or supply passage) 107, and an ink supply opening 109 that communicates to the common ink chamber 108.

The pressure generating means (or actuator means) is provided to apply pressure to the ink within the ink chamber 106 by deforming the vibration plate 102. In this embodiment, an electromechanical conversion element is used as the pressure generating means. The electromechanical conversion element includes two rows of stacked type piezoelectric elements 121 (only one row shown in FIG. 4), and a base substrate 122 on which the piezoelectric elements 121 are bonded and fixed. A support part 123 is provided between two adjacent piezoelectric elements 121. The support parts 123 are formed by parts that are made simultaneously as the piezoelectric elements 121 when a piezoelectric element member is divided into the piezoelectric elements 121 by these parts. Since no driving voltage is applied to these parts that divide the piezoelectric element member into the piezoelectric elements 121, these parts become the support parts 123.

The piezoelectric elements 121 are connected to a flexible printed circuit (FPC) cable 126 that is mounted with a driving circuit (not shown). This driving circuit may be formed by an integrated circuit (IC).

The peripheral edge portion of the vibration plate 102 is bonded to a frame member 130. Recesses that become a penetration part 131 and the common ink chamber 108 are formed in the frame member 130. The penetration part 131 accommodates the actuator unit that is formed by the piezoelectric elements 121 and the base substrate 122. An ink supply hole 132 for supplying the ink from the outside to the common ink chamber 108 is also formed in the frame member 130. For example, the frame member 130 is made of a thermosetting resin such as an epoxy resin or, a polyphenylene sulfite, and is formed by injection molding.

Recesses and holes that become the nozzle communication passages 105 and the ink chambers 106 are formed in a crystal face (110) of the single crystal silicon substrate that forms the flow passage plate 101 by an anisotropic etching using an alkaline etchant such as a potassium hydroxide (KOH) solution. However, it is possible use materials other than the single crystal silicon substrate, such as a stainless steel substrate and a photoconductive resin substrate.

The vibration plate 102 is made of a nickel metal plate that is formed by electroforming, for example. However, it is of course possible to use other materials for the vibration plate 102, such as metal plates and composite members which are combinations of metal and resin plates. The piezoelectric elements 121 and the support parts 123 are bonded on the vibration plate 102 by an adhesive, and the frame member 130 is further bonded thereon by an adhesive.

The nozzles 104 are formed in the nozzle plate 103 in correspondence with each of the ink chambers 106, and have a diameter of approximately 10 μm to approximately 30 μm. The nozzle plate 103 is bonded on the flow passage plate 101 by an adhesive. The nozzle plate 103 is made up of a nozzle forming member made of a metal, a predetermined layer formed on the surface of the nozzle forming member, and a water repellent layer that is formed on the predetermined layer.

The piezoelectric element 121 is formed by a stacked type piezoelectric element (PZT) having piezoelectric materials 151 and internal electrodes 152 that are alternately stacked. The internal electrodes 152 that are alternately drawn out on different end surfaces of the piezoelectric element 121 are respectively connected to an individual electrode 153 and a common electrode 154. The pressure is applied to the ink within the ink chamber 106 by causing the piezoelectric element 121 having a piezoelectric constant of d33 to contract and expand, which in turn causes the volume of the ink chamber 106 to expand and contract. However, it is also possible to apply the pressure to the ink within the ink chamber 106 by causing the piezoelectric element 121 having a piezoelectric constant of d31 to contract and expand. In addition, one row of piezoelectric elements 121 may be provided on a single base substrate 122.

In the ink-jet head having the structure described above, the piezoelectric element 121 contracts by lowering the driving voltage applied to the piezoelectric element 121 from a reference potential. As a result, the vibration plate 102 is lowered to increase the volume of the ink chamber 106, and the ink flows into the ink chamber 106. Thereafter, when the driving voltage applied to the piezoelectric element 121 is increased so as to expand the piezoelectric element 121 in a direction in which the layers forming the piezoelectric element 121 are stacked, the vibration plate 102 is deformed in a direction of the nozzle 104 and the volume of the ink chamber 106 is reduced. Consequently, the pressure is applied to the ink within the ink chamber 106, and the ink drop is eject from the nozzle 104.

By returning the voltage that is applied to the piezoelectric element 121 to the reference potential, the vibration plate 102 returns to its initial position, and the ink chamber 106 expands to generate a negative pressure therein. In this state, the ink is filled into the ink chamber 106 from the common ink chamber 108. After the vibration of an ink meniscus surface at the nozzle 104 decays and stabilizes, the driving voltage is applied to the piezoelectric element 121 for the next ink ejection.

The method of driving the recording head 7 is not limited to that described above, and the ink chamber 106 can be made to contract and expand depending on the manner in which the driving signal waveform, for example, is applied to the piezoelectric element 121.

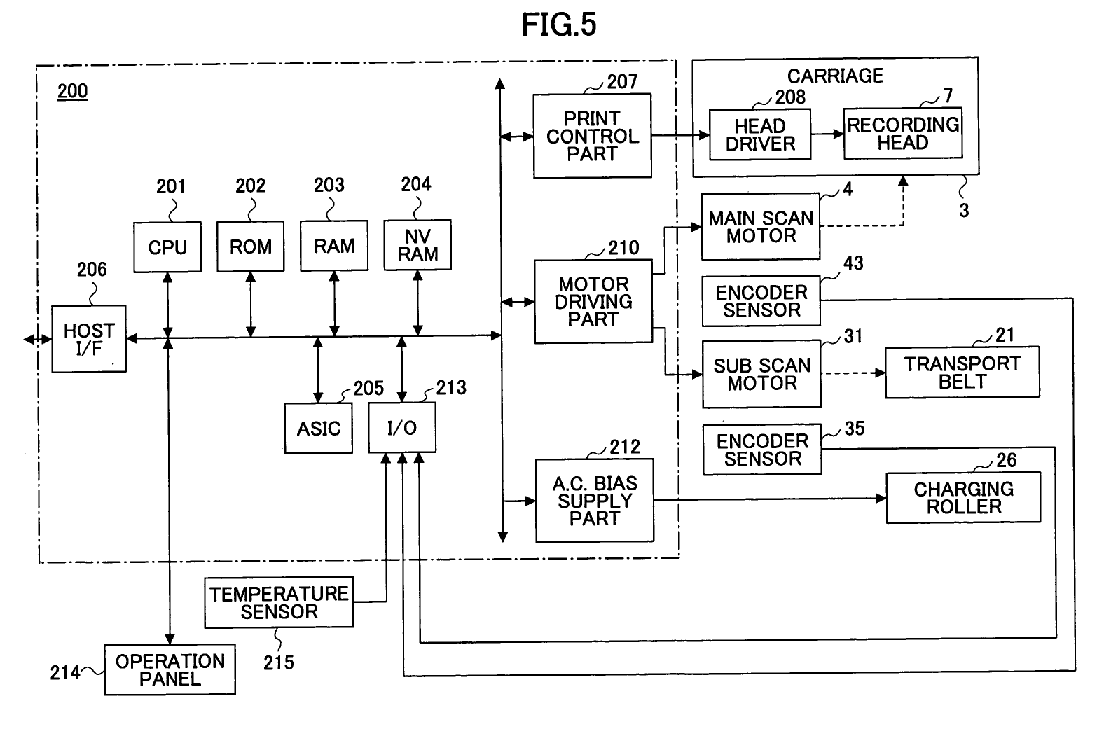

Next, a description will be given of the control part of the image forming apparatus, by referring to FIG. 5. FIG. 5 is a system block diagram generally showing the control part of the image forming apparatus shown in FIG. 1.

A control part 200 shown in FIG. 5 has a CPU 211 for controlling the entire image forming apparatus, a ROM 202 for storing programs to be executed by the CPU 211 and other fixed data, a RAM 203 for temporarily storing image data and the like, a rewritable nonvolatile memory 204 for storing data even while the power of the image forming apparatus is OFF, and an application specific integrated circuit (ASIC) 205. The ASIC 205 carries out various signal processings with respect to the image data, image processing such as rearranging the image data, and processings of input and output signals for controlling the entire image forming apparatus.

The control part 200 also has an interface (I/F) for exchanging data and signals with a host unit (not shown), a print control part 207 that includes a data transfer means for driving and controlling the recording heads 7 and a driving waveform generating means for generating a driving signal waveform, a head driver (driver IC) 208 for driving the recording heads 7 that are mounted on the carriage 3, a motor driving part 210 for riving the main scan motor 4 and the sub scan motor 31, an A.C. bias supply part 212 for supplying the A.C. bias voltage to the charging roller 34, and an input and output (I/O) part 213 for inputting various sensor detection signals, such as the detection signals from encoder sensors 43 and 35 and a detection signal from a temperature sensor 215 that detects the environment temperature. An operation panel 214 including an input device and a display device respectively for inputting and displaying necessary information of the image forming apparatus is connected to the control part 200.

The host unit that is connected to the control part 200 may be formed by an information processing apparatus such as a personal computer, an image reading apparatus such as an image scanner, and an image pickup apparatus (or imaging apparatus) such as a digital camera. The image data and the like from the host unit is received by the host interface 206 via a cable and/or a network.

The CPU 201 within the control part 200 reads and interprets the print data (or recording data) within a reception buffer that is included within the host interface 206, and based on the interpreted print data, the ASIC 205 carries out the necessary image processing such as rearranging of the image data. The processed image data is transferred from the print control part 207 to a head driver 208. As will be described later, dot pattern data used for outputting the image are generated by a printer driver of the host unit.

The print control part 207 transfers the image data to the head driver 208 in the form of serial data. The print control part 207 also transfers to the head driver 208 a transfer clock and latch signal that are required to transfer the image data and to make the transfer definite, ink drop control signals (mask signals) and the like. In addition, the print control part 207 includes a digital-to-analog (D/A) converter (not shown) for subjecting a pattern data of the driving signal stored in the ROM 202 to a D/A conversion, a driving waveform generator (not shown) that is formed by a current amplifier or the like, and a driving waveform selecting means (not shown) for selecting the driving signal waveform to the supplied to the head driver 208. The driving signal waveform that is generated by the print control part 207 and supplied to the head driver 208 is made up of a single driving pulse (driving signal) or a plurality of driving pulses (driving signals).

The head driver 208 selectively applies to the driving element, such as the piezoelectric element 121 described above that generates an energy to eject the ink drop from the corresponding recording head 7, the driving signal forming the driving signal waveform that is received from the print control part 207 based on the image data that are input serially to the control part 200 and amount to one line of the recording heads 7 that is to be driven. In this state, it is possible to form dots having different sizes, such as a large dot (large ink drop), a medium dot (medium ink drop) and a small dot (small ink drop), by selecting the driving pulses forming the driving signal waveform that is supplied to the head driver 208.

The CPU 201 calculates a driving output value (control value) with respect to the main scan motor 4, based on a speed detection value and a position detection value obtained by sampling the detection signal (pulse signal) from the encoder sensor 43 that forms the linear encoder and a speed target value and a position target value obtained from a prestored speed and position profile. The CPU 201 drives the main scan motor 4 via the motor driving part 210 based on the calculated driving output value for the main scan motor 4. Similarly, the CPU 201 calculates a driving output value (control value) with respect to the sub scan motor 31, based on a speed detection value and a position detection value obtained by sampling the detection signal (pulse signal) from the encoder sensor 35 that forms the rotary encoder and a speed target value and a position target value obtained from a prestored speed and position profile. The CPU 201 drives the sub scan motor 31 via the motor driving part 210 based on the calculated driving output value for the sub scan motor 31.

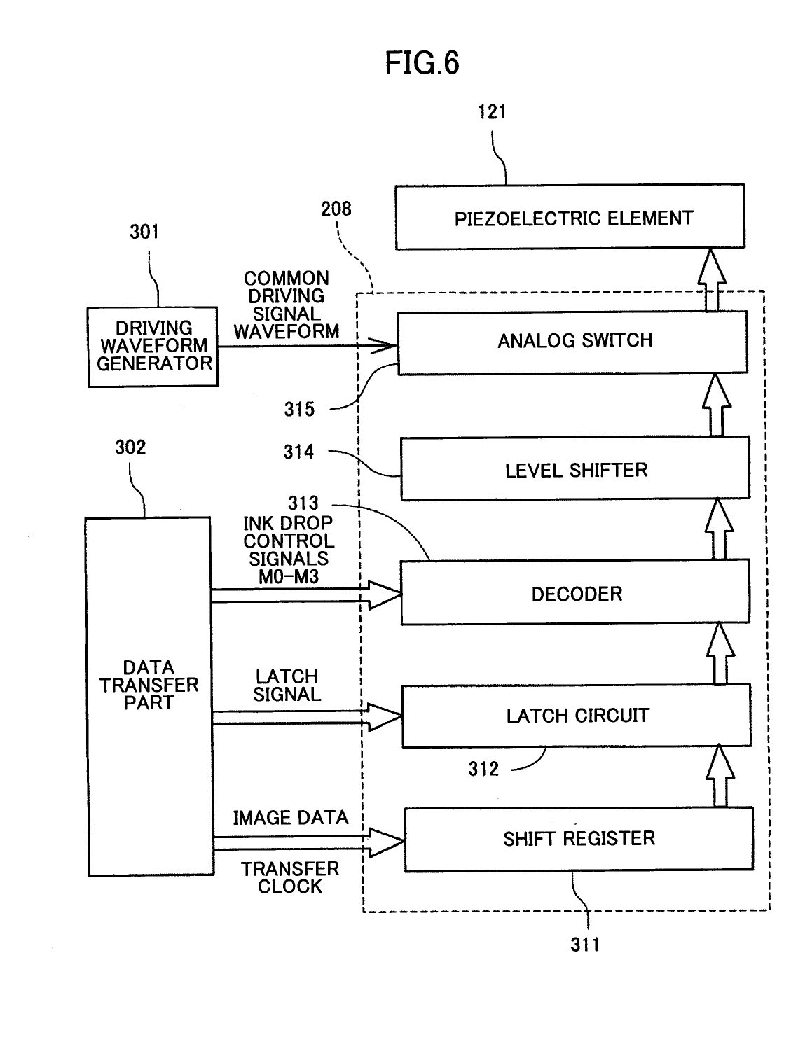

Next, a description will be given of the print control part 207 and the head driver 208, by referring to FIG. 6. FIG. 6 is a system block diagram showing the print control part 207 of the control part 200 shown in FIG. 5.

As shown in FIG. 6, the print control part 207 includes a driving waveform generator 301 for generating and outputting the driving signal waveform (common driving signal waveform) that is formed by a plurality of driving pulses (driving signals) within one print period, and a data transfer part 302 for outputting a 2-bit image data (gradation signal having a level 0 or 1) according to the printing image (or recording image), the clock signal, the latch signal, and ink drop control signals M0 through M3.

Each of the ink drop control signals M0 through M3 is a 2-bit signal that instructs opening or closing of an analog switch 315 within the head driver 208, which forms a switching means, for each ink drop. Each of the ink drop control signals M0 through M3 makes a transition to a high level (ON state) with respect to the waveform to be selected and makes a transition to a low level (OFF state) with respect to the waveform not to be selected, depending on the print period of the common driving signal waveform.

The head driver 208 includes a shift register 311 for inputting the transfer clock (or shift clock) and the serial image data (gradation data having 2 bits per channel) from the data transfer part 302, a latch circuit 312 for latching each resist value of the shift register 311 in response to the latch signal, a decoder 313 for decoding the gradation data and the ink drop control signals M0 through M3 and outputting a decoded result, a level shifter 314 for converting a level of a logic level voltage signal that is output from the decoder 313 as the decoded result into a level at which the analog switch 315 is operable, and the analog switch 315 that is controlled to the closed or open (ON or OFF) state in response to the output of the decoder 313 that is received via the level shifter 314.

The analog switch 316 is connected to the selection electrode (individual electrode) 153 of each piezoelectric element 121 to input the common driving signal waveform from the driving waveform generator 301. Accordingly, by turning the analog switch 3150N depending on the image data (gradation data) that is serially transferred from the data transfer part 302 and the decoded result that is output from the decoder 313 in response to the ink drop control signals M0 through M3, a predetermined driving signal forming the common driving signal waveform passes through the analog switch 315, that is, is selected, and is applied to the piezoelectric element 121.

Next, a description will be given of the ink used by the image forming apparatus. The ink drop which is ejected from the recording head 7 of the image forming apparatus is formed by the printing (recording) ink which may be made up of the following constituent elements (c1)-(c10).

(c1) Pigment (Self-Dispersing Pigment), 6 wt. % or greater;

(c2) First Wetting Agent;

(c3) Second Wetting Agent;

(c4) Soluble Organic Solvent;

(c5) Anion or Nonion Based Surface Active Agent;

(c6) Polyole or Glycol Ether, Carbon Number 8 or Greater;

(c7) Emulsion;

(c8) Preservative;

(c9) pH Adjusting Agent; and

(c10) Pure Water.

In other words, the pigment (c1) is used as the coloring agent for the recording, and the solvent (c4) is used as an essential component to decompose and disperse the pigment (c1). In addition, the first and second wetting agents (c2) and (c3), the surface active agent (c5), the emulsion (c7), the preservative (c8) and the pH adjusting agent (c9) are added as additives. The first and second wetting agents (c2) and (c3) are mixed in order to effectively utilize the characteristics of each of the first and second wetting agents (c2) and (c3), and to facilitate viscosity adjustment.

A more detailed description will now be given of each of the constituent elements (c1)-(c10) of the ink.

The pigment (c1) is not limited to a particular kind, and may be formed by an inorganic pigment or an organic pigment. The inorganic pigment may be selected from titanium oxide, iron oxide and carbon black. The carbon black may be produced by known methods such as the contact method, the furnace method and the thermal method. On the other hand, the organic pigment may be selected from azo pigments, polycyclic pigments, chelating pigments, nitro pigments, nitroso pigments, and aniline pigments such as aniline black. The azo pigments may include azo lakes, insoluble azo pigments, condensation azo pigments, and chelating azo pigments. The polycyclic pigments may include phtalocyanine pigments, perylene pigments, perinone pigments, anthraquinone pigments, quinacridon pigments, dioxazine pigments, thioindigo pigments, isoindrinone pigments, and quinophtharone pigments. The chelating pigments may include basic chelating pigments and acid chelating pigments.

Of the above described pigments, the ink used in this embodiment preferably has a good affinity with water. The grain diameter of the pigment is preferably in a range of 0.05 μm to 10 μm, and more preferably 1 μm or less, and most preferably 0.16 μm or less. The amount of pigment within the ink, as the coloring agent, is preferably in a range of 6 wt. % to 20 wt. %, and more preferably in a range of 8 wt. % to 12 wt. %.

Particular examples of the pigments within the ink used in this embodiment are as follows.

The black pigment may be selected from carbon blacks (C. I. pigment black 7) such as furnace black, lampblack, acetylene black and channel black, metals such as copper, iron (C. I. pigment black 11) and titanium oxide, and organic pigments such as aniline black (C. I. pigment black 1).

Color pigments may be selected from C. I. pigment yellows 1 (fast yellow G), 3, 12 (diazo yellow AAA), 13, 14, 17, 24, 34, 35, 37, 42 (yellow iron oxide), 53, 55, 81, 83 (diazo yellow HR), 95, 97, 98, 100, 101, 104, 108, 109, 110, 117, 120, 138 and 153, C. I. pigment oranges 5, 13, 16, 17, 36, 43 and 51, C. I. pigment reds 1, 2, 3, 5, 17, 22 (brilliant fast scarlet), 23, 31, 38, 48:2 (permanent red 2B (Ba)), 48:2 (permanent red 2B (Ca)), 48:3 (permanent red 2B (Sr)), 48:4 (permanent red 2B (Mn)), 49:1, 52:2, 53:1, 57:1 (brilliant carmine 6B), 60:1, 63:1, 63:2, 54:1, 81 (rhodamine 6G lake), 83, 88, 101 (rouge), 104, 105, 106, 108 (cadmium red), 112, 114, 122 (quinacridon magenta), 123, 146, 149, 166, 168, 170, 172, 177, 178, 179, 185, 190, 193, 209 and 219, C. I. pigment violets 1 (rhodamine lake), 3, 5:1, 16, 19, 23 and 38, C. I. pigment blues 1, 2, 15 (phtalocyanine blue R), 15:1, 15:2, 15:3 (phtalocyanine blue E), 16, 17:1, 56, 60 and 63, and C. I. pigment greens 1, 4, 7, 8, 10, 17, 18 and 36.

Of course, other pigments may be used, such as graft pigments having the surface of the pigment (for example, carbon) processed by a resin or the like so as to be dispersible in water, and processed pigments having the surface of the pigment (for example, carbon) added with a functional group such as sulfone group and carboxyl group so as to be dispersible in water.

The pigment may also be encapsulated within microcapsules so as to be dispersible in water.

The black ink used in this embodiment preferably includes, as the pigment, a pigment dispersant which is obtained by dispersing the pigment within a water medium by a dispersing agent. The dispersing agent is preferably a known dispersant which is used to adjust a known pigment dispersant.

The dispersant may be selected from polyacrylic acid, polymethacrylate, acrylic acid-acrylonitrile copolymer, vinyl acetate-acrylic (acid) ester copolymer, acrylic acid-acrylic (acid) alkylester copolymner, styrene-acrylic acid copolymner, styrene-methacrylic acid copolymer, styrene-acrylic acid-acrylic (acid) alkylester copolymer, styrene-methacrylic acid-acrylic (acid) alkylester copolymer, styrene-α-methyl styrene-acrylic acid copolymer-acrylic (acid) alkylester copolymer, styrene-maleic acid copolymer, vinyl naphthalene-maleic acid copolymer, vinyl acetate-ethylene copolymer, vinyl acetate-fatty acid vinyl ethylene copopymer, vinyl acetate-maleic acid ester copolymer, vinyl acetate-crotonic acid copolymer, and vinyl acetate-acrylic acid copolymer.

In the ink used in this embodiment, the weight average molecular weight of these copolymers is preferably in a range of 3,000 to 50,000, and more preferably in a range of 5,000 to 30,000, and most preferably in a range of 7,000 to 15,000. The amount of the dispersing agent may be added within an appropriate range such that the pigment is stably dispersed and other desirable effects are not lost. The dispersing agent is preferably in a range of 1:0.06 to 1:3, and more preferably in a range of 1:0.125 to 1:3.

The pigment used as the coloring agent amounts to 6 wt. % to 20 wt. % with respect to the total wt. % of the ink, and the grain diameter is in a range of 0.05 μm to 0.16 μm. In addition, the pigment is dispersed within water by the dispersing agent, and the dispersing agent used is a macromolecular dispersing agent having a molecular weight in a range of 5,000 to 100,000. The picture quality is improved when the soluble organic solvent includes at least one kind of pyrrolidone derivative, and particularly 2-pyrrolidone.

With regard to the first and second wetting agents (c2) and (c3) and the soluble organic solvent (c4), water is included within the ink as a liquid medium in the case of the ink used in this embodiment. For example, the following soluble organic solvents may be used for the purposes of making the ink have desired properties, preventing drying of the ink, and improving the dissolution. A plurality of such soluble organic solvents may be mixed.

The first and second wetting agents (c2) and (c3) and the soluble organic solvent (c4) may be selected from polyhydric alcohols such as ethylene glycol, diethylene glycol, triethylne glycol, propylene glycol, dipropylene glycol, tripropylene glycol, tetraethylene glycol, hexylene glycol, polyethylene glycol, polypropylene glycol, 1,5-pentanediol, 1,6-hexanediol, glycerol, 1,2,6-haxanetriol, 1,2,4-butanetriol, 1,2,3-butanetriol, and petriol.

The first and second wetting agents (c2) and (c3) and the soluble organic solvent (c4) may also be selected from polyhydric alcohol alkylethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether.

The first and second wetting agents (c2) and (c3) and the soluble organic solvent (c4) may also be selected from polyhydric alcohol aryl ethers such as ethylene glycol monophenyl ether, and ethylene glycol monobenzyl ether.

The first and second wetting agents (c2) and (c3) and the soluble organic solvent (c4) may also be selected from nitrogen-containing heterocyclic compounds such as 2-pyrrolidone, N-methyl-2-pyrrolidone, N-hydroxyethyl-2-pyrrolidone, 1,3-dimethylimidazolidinone, ε-caprolactam, and γ-butyrolactone.

The first and second wetting agents (c2) and (c3) and the soluble organic solvent (c4) may also be selected from amides such as formamide, N-methyl formamide, and N,N-dimethyl formamide.

The first and second wetting agents (c2) and (c3) and the soluble organic solvent (c4) may also be selected from amines such as monoethanol amine, diethanol amine, reiethanol amine, monoethyl amine, diethyl amine, and triethyl amine.

The first and second wetting agents (c2) and (c3) and the soluble organic solvent (c4) may also be selected from sulfur-containing compounds such as dimethyl sulfoxide, sulfolane, and thiodiethanol, propylene carbonate, and ethylene carbonate.

Of the above described organic solvents, diethylene glycol, thiodiethanol, polyethylene glycol 200-600, trienthylene glycol, glycerol, 1,2,6-hexanetriol, 1,2,4-butanetriol, petriol, 1,5-pentanediol, 2-pyrrolidone, and N-methyl-2-pyrrolidon are particularly preferable since these solvents have the effect of obtaining satisfactory dissolution and preventing deterioration of the ink ejection characteristic.

Other preferable wetting agents include sugar. Sugars may include polysaccharides such as monosaccharide, disaccharide, and oligosaccharide (including trisaccharide and tetrasaccharide), and preferably glucose, mannose, fructose, ribose, xylose, arabinose, galactose, maltose, cellobiose, lactose, sucrose, trehalose, and maltotriose. The polysaccharides are used to refer to sugars in a broad sense, and may include naturally existing materials such as α-cyclodextrine and cellulose.

In addition, derivatives of these sugars may include reducing sugar (for example, sugar alcohol (general formula HOCH₂(CHH)ₙCH₂OH (where n is an integer from 2 to 5) of the above described sugars, sugar oxide (for example, aldonic acid and uronic acid), amino acid, and thio acid. Sugar alcohol is particularly preferable, and may include maltitol and sorbit.

The sugar content within the in composition is preferably in a range of 0.1 wt. % to 40 wt. %, and more preferably in a range of 0.5 wt. % to 30 wt. %.

The surface active agent (c5) is not limited to a particular kind. For example, anionic surface active agent may be selected from polyoxyethylene alkylether acetate salt, dodecylbenzenesulfonic acid salt, lauryl acid salt, and polyoxyethylene alkylether sulfate salt.

For example, nonionic surface active agent may be selected from polyoxyethylene alkylether, polyoxyethylene alkylester, polyoxyethylene sorbitane fatty-acid ester, polyoxyethylene alkylfenyl ether, polyoxyethylene alkylamine, and polyoxyethylene alkylamide. The above described surface active agents may be used independently or, a mixture of two or more surface active agents may be used.

The surface tension of the ink used in this embodiment corresponds to an index indicating the permeability of the ink with respect to the recording paper. This surface tension indicates a dynamic surface tension within a short time of one second or less from the time when the ink surface is formed, and is different from a static surface tension which is measured in saturation time. A known method of measuring the dynamic surface tension within one second or less may be employed, including a method proposed in a Japanese Laid-Open Patent Application No. 63-31237. In this embodiment, a Wilhelmy type suspended plate surface tension measuring equipment is employed to measure the dynamic surface tension. The surface tension is preferably 40 mJ/m² or less, and more preferably 35 mJ/m² or less, so as to obtain satisfactory fixing characteristic and drying characteristic.

With regard to the polyole or glycol ether (c6) with carbon number 8 or greater, a partially soluble polyole and/or glycol ether having a solubility in a range of 0.1 wt. % to 4.5 wt. % within water at a temperature of 25° C. is/are added to the ink at a proportion of 0.1 wt. % to 10.0 wt. % with respect to the total weight of the ink. As a result, the wetting characteristic of the ink with respect to the heating element is improved, and it was confirmed by the present inventors that ink ejection stability and frequency stability are achieved even when the amount of polyol and/or glycol ether added is small. For example, the solubility was 4.2% at 20° C. for 2-ethyl-1,3-hexanediol, and the solubility was 2.0% at 25° C. for 2,2,4-trimethyl-1,3-pentanediol.

The penetrant having the solubility in the range of 0.1 wt. % to 4.5 wt. % within water at 25° C. has an advantage in that the permeability is extremely high although the solubility is low. Hence, it is possible to produce an ink having an extremely high permeability by combining the penetrant having the solubility in the range of 0.1 wt. % to 4.5 wt. % within water at 25° C. with other solvents and/or other surface active agents.

It is preferable that the ink used in this embodiment is added with the emulsion (c7), such as resin emulsion. The resin emulsion refers to an emulsion having water in the continuous phase and a resin components in the disperse phase. The resin component in the disperse phase may be selected from acrylic resin, vinyl acetate resin, styrene-butadiene resin, vinyl chloride resin, acrylic-styrene resin, butadiene resin, and styrene resin.

Preferably, the resin component in the ink which is used in this embodiment is a copolymer having both a hydrophilic part and a hydrophobic part. In addition, although the grain diameter of the resin component is not limited as long as the emulsion is formed, the grain diameter is preferably approximately 150 nm or less, and more preferably in a range of 5 nm to 100 nm.

The resin emulsion may be obtained by mixing the resin grains into water, in some cases together with a surface active agent. For example, acrylic resin or styrene-acrylic resin emulsion may be obtained by mixing (meta) acrylic (acid) ester and/or styrene to water, in some cases together with a surface active agent. The mixture ratio of the resin component and the surface active agent is preferably in a range of approximately 10:1 to approximately 5:1. If the surface active agent used does not amount to this range, the emulsion is difficult to obtain. On the other hand, it is undesirable for the surface active agent used to exceed this range, because there is a tendency for the water resistance and the permeability of the ink to deteriorate in such a case.

The ratio of the resin which is used as the disperse phase component of the emulsion and the water is preferably in a range of 60 wt. % to 400 wt. % with respect to 100 wt. % resin, and more preferably in a range of 100 wt. % to 200 wt. % with respect to 100 wt. % resin.

Existing resin emulsions include styrene-acrylic resin emulsions called Microgel E-1002 and Microgel E-5002 (both product names) manufactured by Nippon Paint Co., Ltd., acrylic resin emulsion called BonCoat 4001 (product name) manufactured by Dai Nippon Ink Chemical Industry Limited, styrene-acrylic resin emulsion called BonCoat 5454 (product name) manufactured by Dai Nippon Ink Chemical Industry Limited, styrene-acrylic resin emulsion called SAE-1014 (product name) manufactured by Nippon Zeon Company Limited, and acrylic resin emulsion called Saibinol SK-200 (product name) manufactured by Saiden Chemical Company Limited.

The ink used in this embodiment preferably includes the resin emulsion having the resin component in a range of 0.1 wt. % to 40 wt. % of the ink, and more preferably in a range of 1 wt. % to 25 wt. % of the ink.

The resin emulsion has viscosity-increasing and aggregating characteristics, and has the effects of suppressing the penetration of the coloring component and promoting the fixing of the coloring component on the recording medium such as paper. In addition, depending on the kind of resin emulsion, a coating is formed on the recording medium, so as to improve the resistance of the recorded image against friction.

The ink used in this embodiment may use a known preservative (c8), a known pH adjusting agent, and pure water (c10), in addition to the coloring agent (c1), solvent (c4) and surface active agent (c5) described above.

For example, the preservative (or anti-mold agent) (c8) may be selected from sodium dehydroacetate, sodium sorbate, 2-pyridinethiol-1-sodium oxide, sodium benzoate, and sodium pentachlorophenol.

An arbitrary material may be used for the pH adjusting agent, as long as it is possible to adjust the pH to seven or greater without introducing undesirable effects on the ink. For example, the pH adjusting agent may be selected from amines such as diethanol amine and triethanol amin, hydroxides of alkaline metal elements such as lithium hydroxide, sodium hydroxide and potassium hydroxide, ammonium hydroxide, quaternary ammonium hydroxide, quaternary phosphonium hydroxide, and carbonates such as lithium carbonate, sodium carbonate and potassium carbonate.

For example, a chelating reagent may be selected from ethylenediamine sodium tetroacetate, nitro sodium triacetate, hydroxyethyl ethylenediamine sodium triacetate, eiethylene triamine sodium pentoacetate, and uramil sodium diacetate.

For example, the corrosion inhibiter may be selected from acid sulfite, sodium thiosulfate, thiodiglycolic acid ammonium nitrite, diisopropyl ammonium nitrite, pentaerythritol tetranitrate, and dicyclohexyl ammonium nitrite.

By forming the ink to include at least the pigment (c1), the soluble organic solvent (c4), the polyole or glycol ether (c6) with carbon number 8 or greater, and the pure water (c10), it is possible to obtain the following advantageous effects (E1)-(E6) even when the recording is made on plain paper.

(E1) Good color tone (sufficient color generation and color reproducibility);

(E2) High image tone;

(E3) Sharp picture quality free of feathering phenomenon and color bleeding phenomenon in the characters and image;

(E4) Image having little ink penetrating phenomenon to the other side of the recording medium and applicable to duplex recording;

(E5) High ink drying characteristic (fixing characteristic) suited for high-speed recording; and

(E6) High ruggedized characteristic such as light resistance and water resistance of the image.

Therefore, it is possible to greatly improve the image tone, color generation, color reproducibility, feathering, color bleeding, duplex recording characteristic, fixing characteristic and the like, to thereby realize a high picture quality.

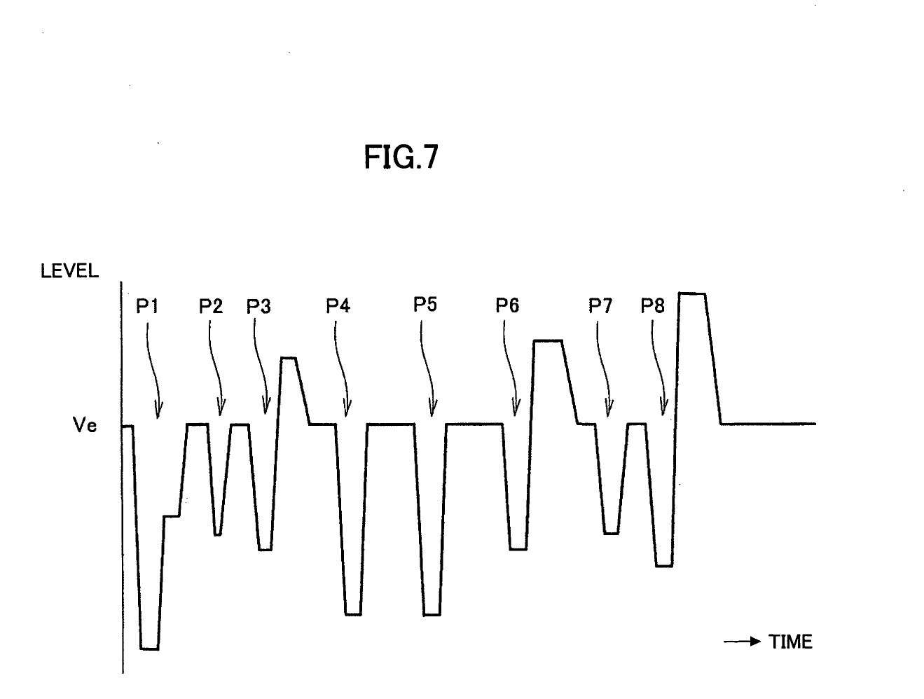

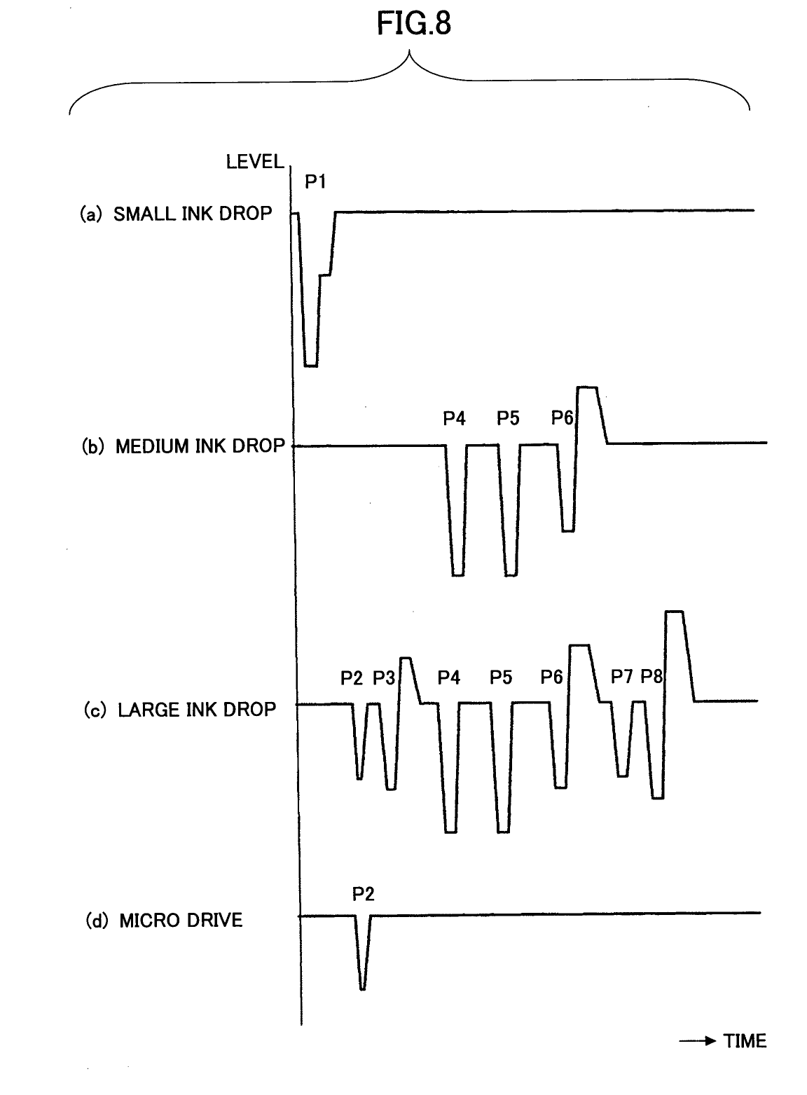

Next, a description will be given of preferable driving signal waveforms to be used for the inks described above, by referring to FIGS. 7 and 8. FIG. 7 is a diagram showing a driving signal waveform generated by the driving waveform generator 301 of the print control part 207 shown in FIG. 6, and FIG. 8 is a timing chart for explaining driving signals selected from the driving signal waveform to realize (a) a small ink drop, (b) a medium ink drop, (c) a large ink drop and (d) a micro drive.

The driving waveform generator 301 generates a driving signal (driving signal waveform) made up of eight driving pulses P1 through P8 shown in FIG. 7 within one print period (one driving period). Each of the driving pulses P1 through P8 is formed by a waveform element that falls from a reference potential Ve and a waveform element that rises after the fall. The driving pulses to be used, of the driving pulses P1 through P8, are selected depending on the ink drop control signals M0 through M3 from the data transfer part 302.

A potential V of the driving pulse formed by the waveform element that falls from the reference potential Ve causes the piezoelectric element 121 to contract and consequently expand the volume of the ink chamber 106. On the other hand, the potential V of the driving pulse formed by the waveform element that rises after the fall causes the piezoelectric element 121 to expand and consequently contract the volume of the ink chamber 106.

Depending on the ink drop control signals M0 through M3 from the data transfer part 302, the driving pulse P1 is selected as shown in FIG. 8(a) when forming the small ink drop (small dot), the driving pulses P4 through P6 are selected as shown in FIG. 8(b) when forming the medium ink drop (medium dot), the driving pulses P2 through P8 are selected as shown in FIG. 8(c) when forming the large ink drop (large dot), and the driving pulse P2 is selected as shown in FIG. 8(d) when making a micro drive that vibrates the meniscus surface at the nozzle 104 without ejecting the ink from the nozzle 104. The driving signal waveform formed by the selected driving pulse or pulses is applied to the piezoelectric element 121 of the recording head 7.

When forming the medium ink drop, a first ink drop is ejected from the nozzle 104 in response to the driving pulse P4, a second ink drop is ejected in response to the driving pulse P5, and a third ink drop is ejected in response to the driving pulse P6, so that the first through third ink drops are combined during flight into a single ink drop that lands the recording medium 12. If a natural vibration period of the ink chamber 106 (that is, the pressure chamber) is denoted by Tc, it is preferable that an interval between the ink ejection timings of the driving pulses P4 and P5 is 2Tc±0.5 μm. The driving pulses P4 and P5 both fall to the bottom level and then rises. For this reason, if the driving pulse P6 also falls to the same bottom level and then rises, the ink drop velocity becomes too high and may deviate from the landing position of the ink drops of other sizes. Hence, the driving pulse P6 is made to fall to a level higher than the bottom level (that is, the potential drop is made smaller), so as to reduce the pull of the meniscus surface at the nozzle 104 and to suppress the increase of the ink drop velocity of third ink drop. However, the potential to which the driving pulse P6 rises after the fall is not reduced, so as to obtain the necessary ink drop volume.

In other words, when the driving signal waveform is made up of a plurality of driving pulses, the last pulse is made to fall by a relatively small potential drop, so as to make the ink drop velocity responsive to the last pulse relatively low and match the landing position of the ink drop with respect to the landing position of the ink drops of other sizes.

The driving pulse P2 vibrates the meniscus surface at the nozzle 104 without ejecting the ink from the nozzle 104, so as to prevent the meniscus surface from drying. In the non-recording region, the driving pulse P2 is applied to the recording head 7 to realize the micro drive. In addition, by using this driving pulse P2 as one of the driving pulses when forming the large ink drop, it is possible to shorten the driving period and realize a high-speed recording.

In addition, by setting the interval between the ink ejection timings of the driving pulses P2 and P3 to 2Tc±0.5 μm, where Tc denotes the natural vibration period, it is possible to in effect increase the volume of the ink drop that is ejected in response to the driving pulse P3. In other words, by superimposing the pressure vibration of the ink chamber 106 caused by the vibration period of the driving pulse P2 to the expansion of the ink chamber 106 caused by the driving pulse P3, it is possible to increase the volume of the ink drop ejected in response to the driving pulse P3 following the driving pulse P2, when compared to the case where the ink drop is ejected solely in response to the driving pulse P3.

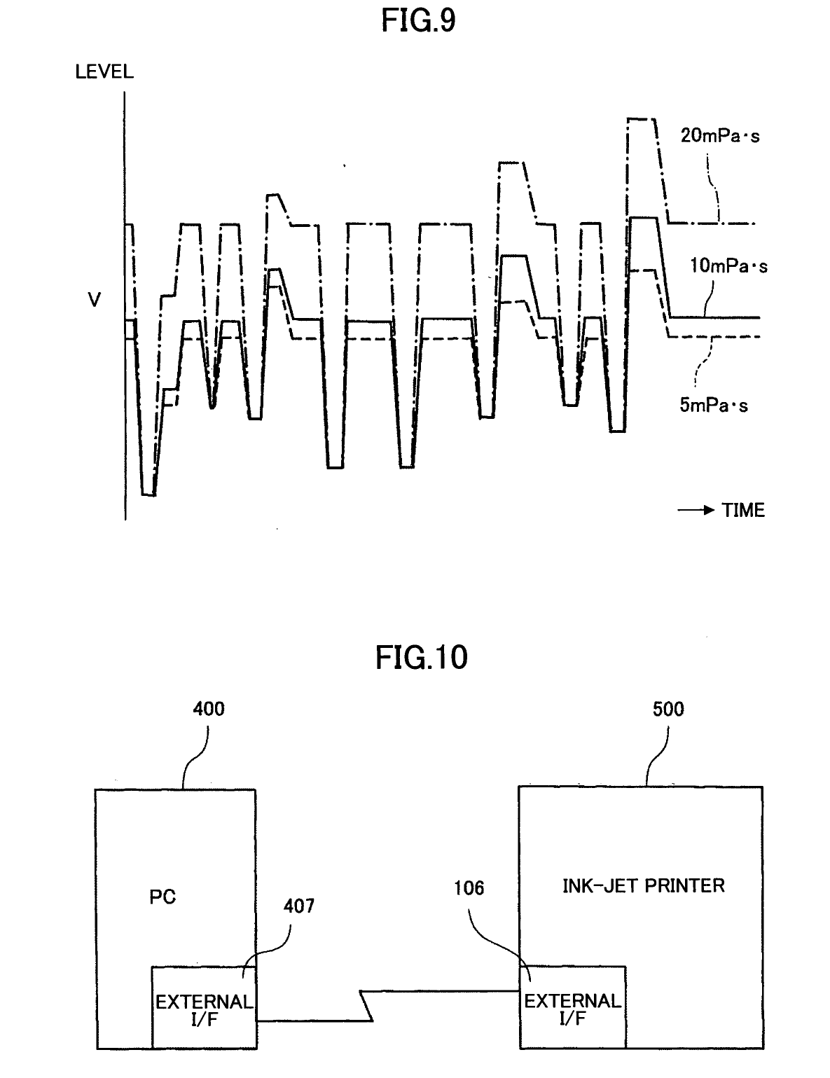

The required driving signal waveform differs depending on the viscosity of the ink. Accordingly, in the image forming apparatus of this embodiment, different driving signal waveforms are provided with respect to the difference ink viscosities. FIG. 9 is a diagram for explaining the driving signal waveform depending on the ink viscosity. As shown in FIG. 9, a driving signal waveform indicated by a dotted line is provided with respect to the ink viscosity of 5 mPa·s, a driving signal waveform indicated by a solid line is provided with respect to the ink viscosity of 10 mPa·s, and a driving signal waveform indicated by a one-dot chain line is provided with respect to the ink viscosity of 20 mPa·s. The ink viscosity may be judged from the temperature detected by the temperature sensor 215. Hence, the CPU 201 may judge the ink viscosity from on the temperature detected by the temperature sensor 215, and select the driving signal waveform to be used from the provided driving signal waveforms based on the ink viscosity.

In other words, the driving pulse voltage is set relatively small when the ink viscosity is small, and the driving pulse voltage is set relatively large when the ink viscosity is large, so that the velocity and volume of the ink drop that is ejected from the recording head 7 are maintained approximately constant regardless of the ink viscosity (or temperature). In addition, a peak value of the driving pulse P2 is selected depending on the ink viscosity so that it is possible to vibrate the meniscus surface without ejecting the ink drop.

By using the driving signal waveform that is formed by the driving pulses described above, it is possible to control the time it takes for each of the large, medium and small ink drops to land on the recording medium 12. For this reason, even if the time when the ink ejection starts differs for the large, medium and small ink drops, it becomes possible to make each of the large, medium and small ink drops land at approximately the same position on the recording medium 12.

Next, a description will be given of an image processing apparatus and the image forming apparatus described above, which is implemented with a computer-readable program according to the present invention which causes a computer to execute an image processing method according to the present invention for outputting the recorded image by the image forming apparatus.

FIG. 10 is a system block diagram showing an image forming system in the first embodiment of the present invention, which is formed by the image processing apparatus according to the present invention and the ink-jet recording apparatus (ink-jet printer) forming the image forming apparatus of the present invention.

The image forming system (or printer system) shown in FIG. 10 has one or a plurality of image processing apparatuses 400 (only one shown in FIG. 10), and an ink-jet printer (image forming apparatus) 500. The image processing apparatus 400 is formed by a personal computer (PC) or the like. The one or plurality of image processing apparatuses 400 are connected to the ink-jet printer 500 via a predetermined interface or network.

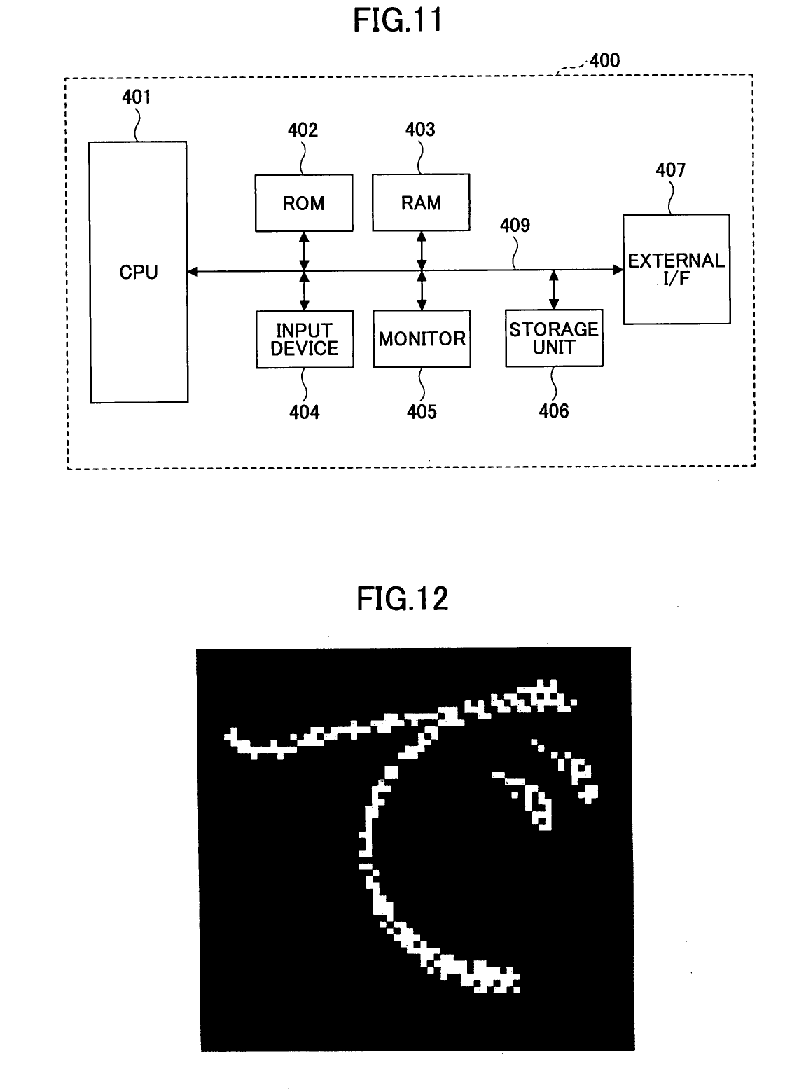

FIG. 11 is a system block diagram showing the image processing apparatus 400 in the image forming system shown in FIG. 10. As shown in FIG. 11, the image processing apparatus 400 has a CPU 401 which is connected to a ROM 402 and a RAM 403 via a bus line 409. The ROM 402 and the RAM 403 form a memory means. A storage unit 406 formed by a magnetic storage apparatus using a hard disk or the like, an input device 404 such as a mouse and a keyboard, and a monitor 405 such as an LCD and a CRT, are connected to the bus line 409 via a predetermined interface. A reading unit (not shown) for reading a recording medium such as an optical disk is also connected to the bus line 409. A predetermined interface (external I/F) 407 for communicating via a network such as the Internet and for communicating with an external equipment such as an USB, is also connected to the bus line 409.

The storage unit 406 of the image processing apparatus 400 stores an image processing program including the computer-readable program according to the present invention. This image processing program is read from the recording medium by the reading unit or, downloaded via a network such as the Internet, and installed into the storage unit 406. By installing this image processing program into the storage unit 406, the image processing apparatus 400 can operate to carry out the image processings described hereunder. This image processing program may be designed to operate in an operating system (OS). Furthermore, this image processing program may for a portion of a specific application software.

The image processing method according to the present invention may be executed in the ink-jet printer, but in the following description, it is assumed for the sake of convenience that the ink-jet printer itself does not have the function of generating the dot pattern that is to be actually recorded in response to a print instruction which instructs plotting of an image or printing (recording) of characters. In other words, it is assumed for the sake of convenience that an image processing is carried out by the printer driver that is embedded as software within the image processing apparatus 400 which forms the host unit, in response to the print instruction from the application software or the like that is executed by the image processing apparatus 400 (the host unit), so as to generate the recording image data (printing image data) of the multi-level dot pattern that can be output by the ink-jet printer 500, and the recording image data is rasterized and transferred to the ink-jet printer 500 which records (prints) and outputs the rasterized data.

More particularly, in the image processing apparatus 400, the instruction from the application or operating system, instructing the plotting of image or the recording of characters, is temporarily stored in a plotting data memory. For example, such an instruction may be written with the position, width (or degree of fatness) and the shape of the line to be recorded or, the font, size and position of the character to be recorded). Such an instruction is written in a predetermined print language.

The instruction that is temporarily stored in the plotting data memory is interpreted by a rasterizer, and is converted into a recording dot pattern in accordance with the instructed position, width (or degree of fatness) and the like in the case where the instruction instructs the recording of the line. In the case where the instruction instructs the recording of the character, the instruction is converted into a recording dot pattern in accordance with the instructed position, size and the like obtained by calling contour information of the corresponding character from font outline data prestored in the image processing apparatus 400 (the host unit). In the case where the instruction instructs the recording of the image data, the image data is converted as it is into the recording dot pattern.

Thereafter, the recording dot pattern (or image data) is subjected to an image processing and stored in a rasterized data memory. In this case, the image processing apparatus 400 regards an orthogonal lattice as a basic recording position, and rasterizes the recording dot pattern into the rasterized data. For example, the image processing may be a γ correction or a color management process (CMM) for adjusting the color, a halftone process such as a dither method or an error diffusion method, a background (color) eliminating process, a process to restrict the total amount of ink, or the like. The rasterized data (recording dot pattern) stored in the rasterized data memory is transferred to the ink-jet printer 500 via the interface.

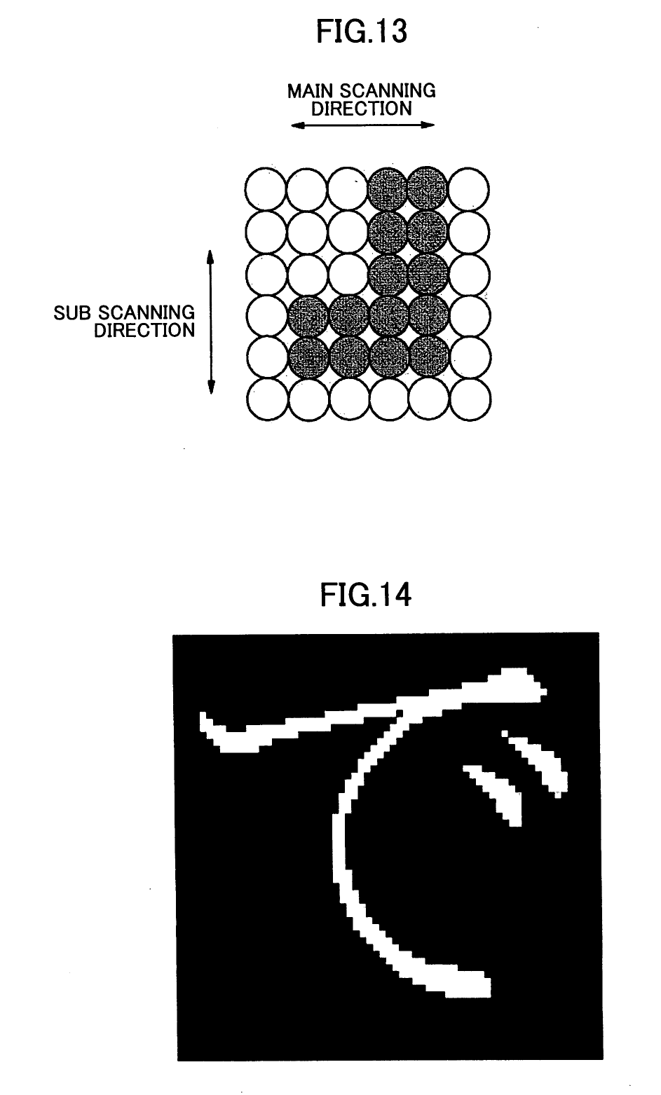

A description will now be given of a process of fattening the white character, by referring to FIG. 12 and the subsequent figures. FIG. 12 is a diagram showing a white character that is formed by a comparison example which does not carry out the character fattening process, and FIG. 13 is a diagram showing dots of an important part on an enlarged scale, for explaining the white character that is formed by this comparison example.

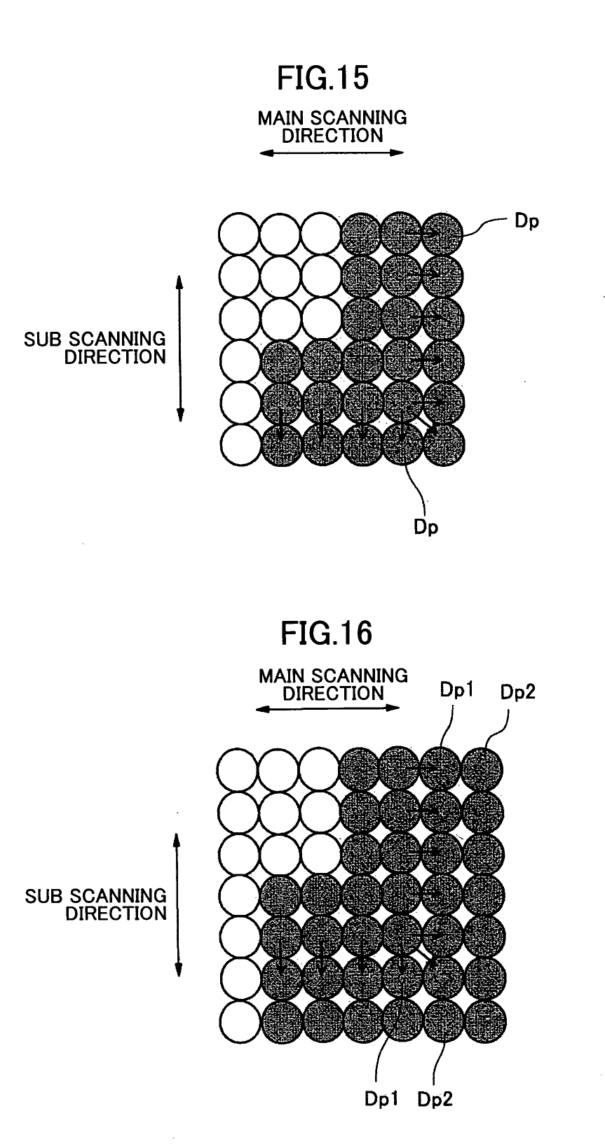

As shown in FIG. 13, the resolution of the image in the sub scanning direction is 300 dpi, for example, and is the same as the nozzle pitch. The resolution of the image in the main scanning direction is 600 dpi, for example, which is two times the resolution in the sub scanning direction. For the sake of convenience, FIG. 13 shows image portions of the white character by black circular marks, and shows background portions by white circular marks. This means that no ink drop lands on the black circular marks, to thereby form the white character. The image portions of the white character and the background portions are illustrated similarly in each of FIGS. 15, 16, 20A through 20C, 21A, 21B, 22A through 22D, 23A and 23B which will be described later. Since the resolution in the main scanning direction is two times that in the sub scanning direction, two dots in the main scanning direction correspond to one dot in the sub scanning direction, but for the sake of convenience, FIG. 13 shows the main scanning direction on a scale that is enlarged to two times the scale of the sub scanning direction, and the main and sub scanning directions are illustrated similarly in each of the figures which will be described later.

FIG. 14 is a diagram showing a white character that is formed by carrying out the character fattening process in this first embodiment of the present invention, and FIG. 15 is a diagram showing dots of an important part on an enlarged scale, for explaining the white character that is formed by carrying out the character fattening process. As shown in FIG. 15, one large ink drop (large dot) Dp is added in the main scanning direction with respect to each dot (indicated by the black circular mark) forming the image portion of the white character background portion and located on the side (right side in FIG. 15) opposite to the side (left side in FIG. 15) adjacent to the dot (indicated by the white circular mark) forming the background portion, and one large ink drop (large dot) Dp is added in the sub scanning direction with respect to each dot (indicated by the black circular mark) forming the image portion of the white character background portion and located on the side (lower side in FIG. 15) opposite to the side (upper side in FIG. 15) adjacent to the dot (indicated by the white circular mark) forming the background portion. As a result, at the boundary of the dots forming the background portion and the dots forming the white character, the dots forming the background portion decrease by an amount the dots forming the white character increases by the character fattening process. Accordingly, even if the black ink forming the background portion bleeds, the bleeding does not appear conspicuous to the human eyes and the white character will not appear deformed because the white character is fattened. In other words, the picture quality of the white character is improved by the character fattening process.

FIG. 16 is a diagram showing dots of an important part on an enlarged scale, for explaining a white character that is formed by another character fattening process in the first embodiment of the present invention. FIG. 16 shows a case where the resolution is high, namely, 600 dpi in the main scanning direction and 600 dpi in the sub scanning direction. In this case, as shown in FIG. 16, two large ink drops (large dots) Dp1 and Dp2 are added in the main scanning direction with respect to each dot (indicated by the black circular mark) forming the image portion of the white character background portion and located on the side (right side in FIG. 16) opposite to the side (left side in FIG. 15) adjacent to the dot (indicated by the white circular mark) forming the background portion, and two large ink drops (large dots) Dp2 are added in the sub scanning direction with respect to each dot (indicated by the black circular mark) forming the image portion of the white character background portion and located on the side (lower side in FIG. 16) opposite to the side (upper side in FIG. 16) adjacent to the dot (indicated by the white circular mark) forming the background portion. As a result, at the boundary of the dots forming the background portion and the dots forming the white character, the dots forming the background portion decrease by an amount the dots forming the white character increases by the character fattening process. Accordingly, even if the black ink forming the background portion bleeds, the bleeding does not appear conspicuous to the human eyes and the white character will not appear deformed because the white character is fattened. In other words, the picture quality of the white character is improved by the character fattening process.

In the case where the resolution is high, the addition of only one ink drop (dot) in both the main and sub scanning direction may not fatten the white character by an amount that is sufficient to eliminate the bleeding of the black ink forming the background portion that is adjacent to the white character. But by adding two ink drops (dots) in both the main and sub scanning directions, it is possible to fatten the white character by an amount that is sufficient to eliminate the bleeding of the black ink forming the background portion that is adjacent to the white character.

At the boundary of the background portion formed by the black ink and the image portion forming the white character, the amount of bleeding of the black ink forming the background portion is approximately constant regardless of the resolution. On the other hand, the width (or degree of fatness) of the white character when one dot is added in both the main and sub scanning directions changes depending on the resolution. Hence, by changing the number of dots to be added in the main and sub scanning directions with respect to the image portion forming the white character, it becomes possible to record white characters having approximately the same picture quality regardless of the resolution.

Next, a more detailed description will be given on the character fattening process with respect to the white character.

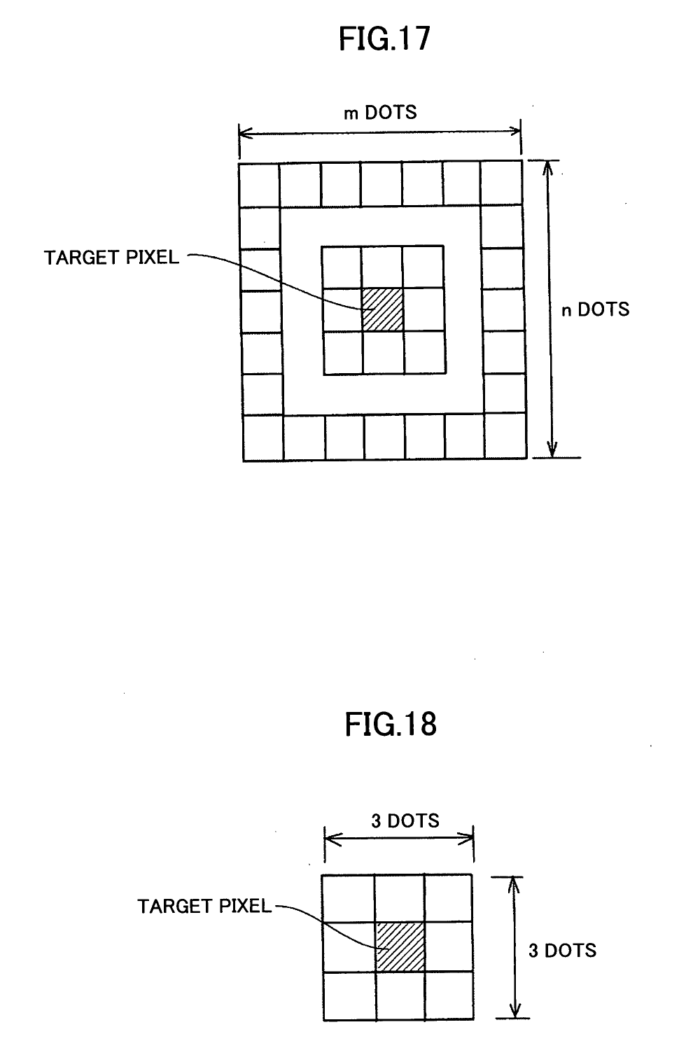

As one method of adding the large dot on the right or left side and on the lower side of the dot in the image portion forming the white character, the pattern matching is suited from the point of view of carrying out the process at a high speed. FIG. 17 is a diagram for explaining a window size used for the pattern matching. FIG. 17 shows an m×n window having m pixels arranged horizontally and n pixels arranged vertically. In the following description, it is assumed for the sake of convenience that m=n and the window size is m×n=3×3, that is, m=3 and n=3 as shown in FIG. 18. FIG. 18 is a diagram for explaining the 3×3 window size.

The font data is developed into the bit-map data by the printer driver (software). The bit-map data indicates the dots forming the font. The bit-map data, indicating the font data, is subjected to the pattern matching in units of the window described above, for each bit.

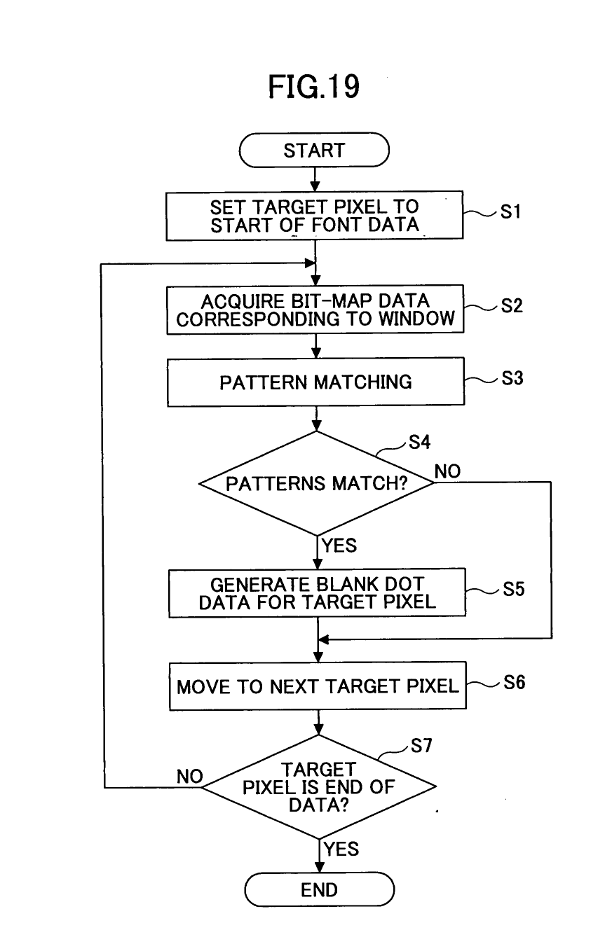

A description will be given of the pattern matching process, that is, the character fattening process, carried out by the printer driver 101A, by referring to FIG. 19. FIG. 19 is a flow chart for explaining the character fattening process (pattern matching process).

First, a step S1 sets a target pixel to a start of the font data. A step S2 acquires the bit-map data of the font data corresponding to the window, by using the target pixel as the center of the window. Hence, the acquired bit-map data corresponds to the data amounting to 3×3=9 dots.

Thereafter, a step S3 carries out a pattern matching by comparing the acquired bit-map data (pattern of the acquired data) and a predetermined reference data (reference pattern) which is set in advance and is used to add the blank dots. A step S4 decides whether or not the compared patterns match. The process advances to a step S5 if the decision result in the step S4 is YES, and the process advances to a step S6 if the decision result in the step S4 is NO.

The step S5 generates the large blank dot data for the target pixel, so as to replace the dot of the target pixel by the large blank dot (large blank ink drop in this particular case). The process advances to the step S6 after the step S5.

The step S6 moves to a next target pixel. In addition, a step S7 decides whether or not the target pixel is the end of data. The process returns to the step S2 if the decision result in the step S7 is NO, so as to repeat the pattern matching until the end of data. On the other hand, the process ends if the decision result in the step S7 is YES.

The process shown in FIG. 19 may treat one pixel as a 1-byte data or, a 1-bit data. When treating one pixel as a 1-byte data, 9 bytes are required to represent data amounting to 9 dots. On the other hand, when treating one pixel as a 1-bit data, only 2 bytes are required to represent data amounting to 9 dots. Hence, the amount of data to be processed is small when one pixel is treated as a 1-bit data, and the required memory capacity can be reduced and the processing speed can be improved in this case.

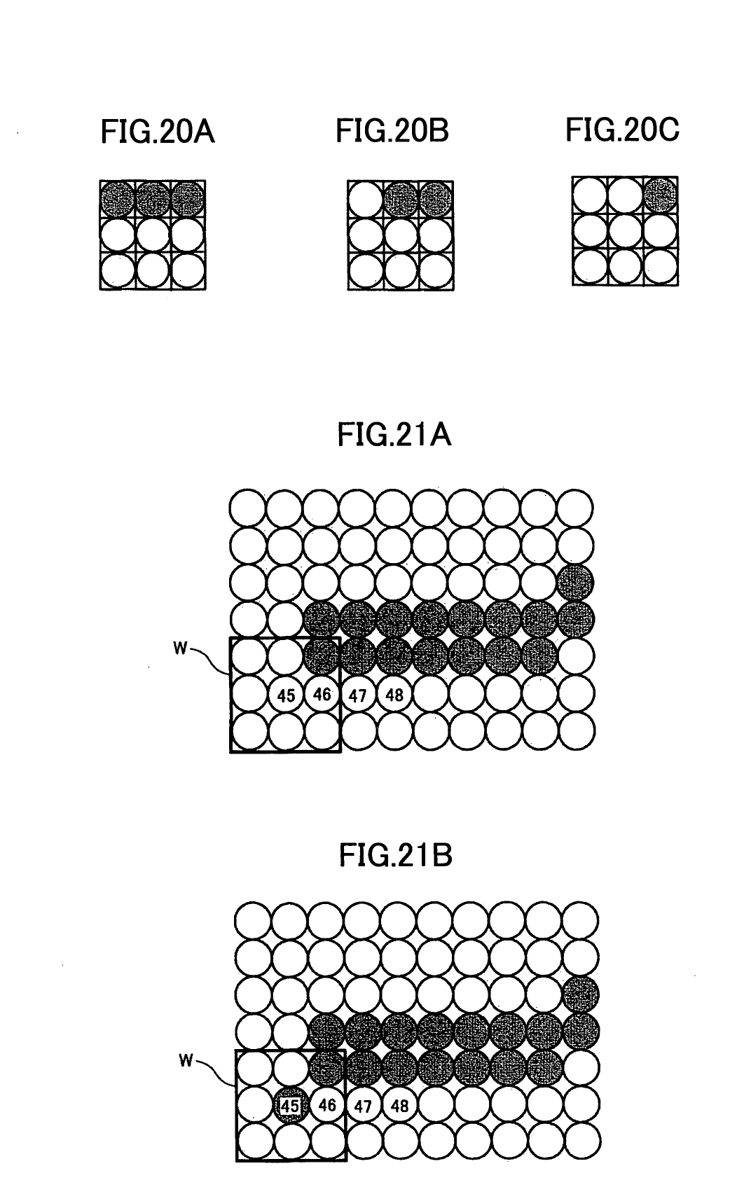

FIGS. 20A through 20C are diagrams for explaining reference patterns of the 3×3 window size used in the character fattening process, and FIGS. 21A and 21B are diagrams for explaining the use of the reference patterns shown in FIGS. 20A through 20C.

When the pattern matching is made with respect to the font data shown in FIG. 21A using the reference patterns shown in FIGS. 20A through 20C, the state of the dots included in a window W having a pixel position (or dot position) 45 of the font data as a target pixel becomes as shown in FIG. 21A, and matches the reference pattern shown in FIG. 20C. Hence, in this case, the dot data of the target pixel 45 is replaced by a blank data, as shown in FIG. 21B.

Similarly, when the window W moves by one pixel (or dot) to the right in FIG. 21A, the state of the dots included in the window W having a pixel position (or dot position) 47 of the font data as the target pixel matches the reference pattern shown in FIG. 20A. Hence, in this case, the dot data of the target pixel 47 is replaced by a blank data.

Because the white character is being recorded, the dots added to the blank portion adjacent to the dots of the white character are not recorded (that is, are blank data). When generating the blank data, the print data represented by “255” is changed to “0” representing the blank if the original font data is represented by “0” (blank) or “255” (print data) as in the case of the bit-map data. The print data represented by “1” is changed to “0” representing the blank if the original font data is represented by “0” (blank) or “11” (print data) as in the case of binary (or bi-level) data.

It is possible to fatten the white character by printing the large dots depending on the font data formed by the data indicating the large dots generated by the pattern matching (in the case of the bit-map data) or, the font data of the original binary data (“0” or “1”) and the binary data (“0” or “1”) of the small dots (in the case of the binary data).

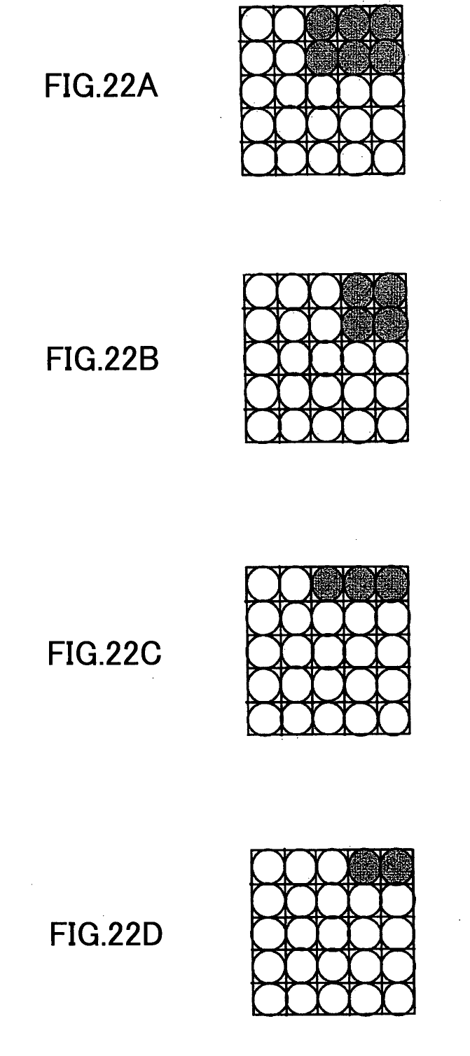

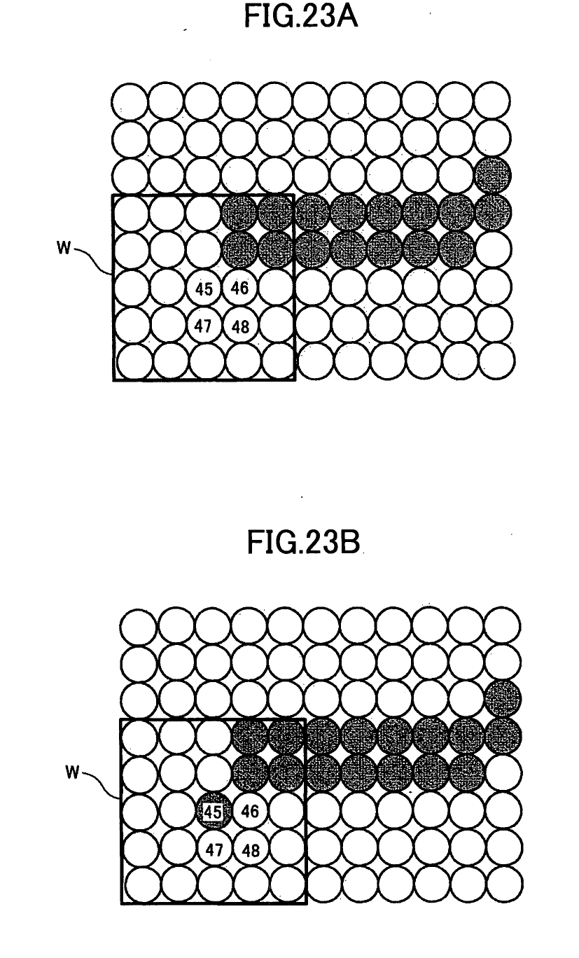

Next, a description will be given of a case where reference patterns of the 5×5 window size are used to fatten the white character by an amount corresponding to 2 dots, by referring to FIGS. 22A through 22D and FIGS. 23A and 23B.

FIGS. 22A through 22D are diagrams for explaining reference patterns of the 5×5 window size used in the character fattening process, and FIGS. 23A and 23B are diagrams for explaining the use of the reference patterns shown in FIGS. 22A through 22D.

When the pattern matching is made with respect to the font data shown in FIG. 23A using the reference patterns shown in FIGS. 22A through 22D, the state of the dots included in a window W having a pixel position (or dot position) 45 of the font data as a target pixel becomes as shown in FIG. 23A, and matches the reference pattern shown in FIG. 23B. Hence, in this case, the dot data of the target pixel 45 is replaced by a blank data, as shown in FIG. 23B.

Similarly, a target pixel 46 is replaced by a blank data using the reference pattern shown in FIG. 22A, a target pixel 47 is replaced by a blank data using the reference pattern shown in FIG. 22C, and a target pixel 48 is replaced by a blank data using the reference pattern shown in FIG. 22D. Accordingly, the 4 dots in the vicinity of the contour portion of the white character are replaced by the blank data.

If the reference patterns of the 3×3 window size are used in the character fattening process in the case where the pixel position D47 shown in FIG. 23A is the target pixel, the contour portion of the white character becomes outside the window W and it is not possible to detect the character portion. But when the window sizes of the reference patterns and the window W are both 5×5, it is possible to detect the character portion and add the blank dot at the pixel position D47. In other words, by increasing the window size of the reference patterns and the window W, it becomes possible to cope with the number of blank dots to be added.

Of course, the window sizes of the reference patterns and the window W are not limited to those described above, and may be determined depending on the extent to which the replacement to the blank dots is to be made and whether or not the processing time is quick enough to cope with the printing speed. Because the amount of data to be compared by the pattern matching process increases as the window sizes of the reference patterns and the window W increase, the time required to carry out the pattern matching process increases as the window sizes of the reference patterns and the window W increase. Hence, from the point of view of reducing the processing time, it is desirable that the window sizes of the reference patterns and the window W are small. On the other hand, the number of dots in the vicinity of the contour portion to be replaced by the blank dots is determined by the picture quality of the character, that is, the extent to which the deformation of the white character is to be improved. Therefore, it is necessary to determine the optimum window sizes of the window and the reference pattern based on the processing speed and the picture quality of the character.

According to experiments conducted by the present inventors, it was found that a sufficient improvement of the picture quality of the character can be obtained even by adding 4 blank dots or, more preferably 6 blank dots, because in the case of the above described ink used in this embodiment, the jaggy between the adjacent dots is reduced by the spreading of the ink. Furthermore, it was also found that a sufficient improvement of the processing speed can be obtained, and that a throughput of 10 PPM or greater is obtainable. Thus, the window size is preferably set to m=13 or less that enables the detection of the 6 dots.

The font data added with the blank dots at the blank portion (that is, the dots of the background portion replaced by the blank dots) in the manner described above were printed on plain paper using the ink-jet head under the following conditions, and the picture quality of the character (that is, the character quality) was evaluated.
Head: 384 nozzles/color
   Nozzle pitch=84 μm (corresponding to 300 dpi)
Image Resolution: 600 dpi in the main scanning direction,
   300 dpi in the sub scanning direction
Dot Size: Large ink drop=87 μm,
   Medium ink drop=60 μm,
   Small ink drop=40 μm
Character: MS Mincho typeface,
   Font size=6, 10, 12, 20, 30, 50 & 80 points
Replacement Method: Using reference patterns having the 5×5 window size shown in FIGS. 22A through 22D
Printing Method Path number (number of scans forming 1 line)=1, No interlacing
Paper: Plain paper (Type 6200 (product name)) manufactured by Ricoh Company, Ltd.

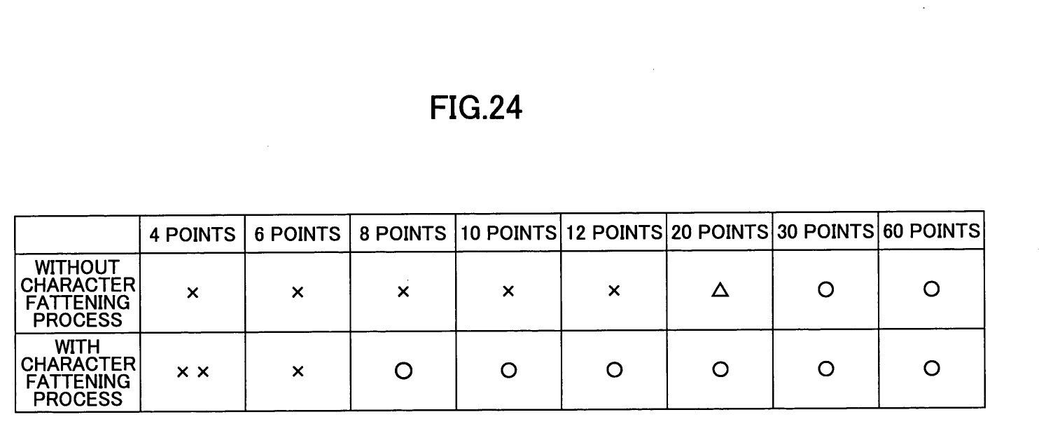

FIG. 24 is a diagram showing evaluation results with and without the character fattening process of this embodiment, for the various character sizes. In FIG. 24, “xx” indicates that the character is deformed and the character quality is extremely poor, “x” indicates that the width (or degree of fatness) of the character is narrow (or thin) and the character quality is poor, “Δ” indicates that the width (or degree of fatness) of the character is slightly narrow (or thin), “o” indicates that the character quality is good and the character is easy to read or recognize.

From the evaluation results shown in FIG. 24, it was confirmed that the character quality is improved, thereby improving the visibility of the character and making the character more easily readable or recognizable by carrying out the character fattening process of this embodiment. Furthermore, it was confirmed that the image tone of the character is sufficiently high and no feathering occurs.

As may be seen from FIG. 24, it was found that the character quality deteriorates if the font size is too small. This is because, in the case of the font size that is too small, the intervals of the dots forming the character are extremely narrow, and the character fattening process would deform the character when the dots are added. It was confirmed that extremely good effects of the character fattening process are obtained when the font size is 8 points or greater.

Although plain paper is used as the recording medium in the description given above, it is also possible to apply the present invention to other recording media such as coated paper, glossy or calendered paper and OHP films, and obtain similar effects. It is also possible to selectively carry out the character fattening process (or not carry out the character fattening process) depending on the kind of recording medium. Hence, it is possible to realize a character having an optimum width (or degree of fatness) depending on the width (or degree of fatness) of the character on the recording medium on which the feathering or bleeding easily occurs and on the recording on which the feathering or bleeding uneasily occurs.

Furthermore, although the characters were printed at 300 dpi in both the main and sub scanning directions or, at 600 dpi in both the main and sub scanning directions in the above described case, it is of course possible to obtain similar effects when printing the characters at other resolutions. In addition, the resolutions in the main and sub scanning directions may differ, such as 600 dpi in the main scanning direction and 300 dpi in the sub scanning direction, 400 dpi in the main scanning direction and 400 dpi in the sub scanning direction, and 300 dpi in the main scanning direction and 150 dpi in the sub scanning direction. It is possible to obtain similar effects when printing the characters with the resolutions that differ in the main and sub scanning directions.

On the other hand, in the case where the resolution is 150 dpi, for example, and low in both the main and sub scanning directions, the white character may become too fat and touch an adjacent character or, the white character itself may become deformed, if one dot (blank dot) is added in the main and sub scanning directions with respect to the image portion forming the white character. For this reason, from the point of view of improving the character quality, it is preferable to provide a mode in which the character fattening process is carried out and a normal mode in which no character fattening process is carried out, and to select the mode depending on the resolution.

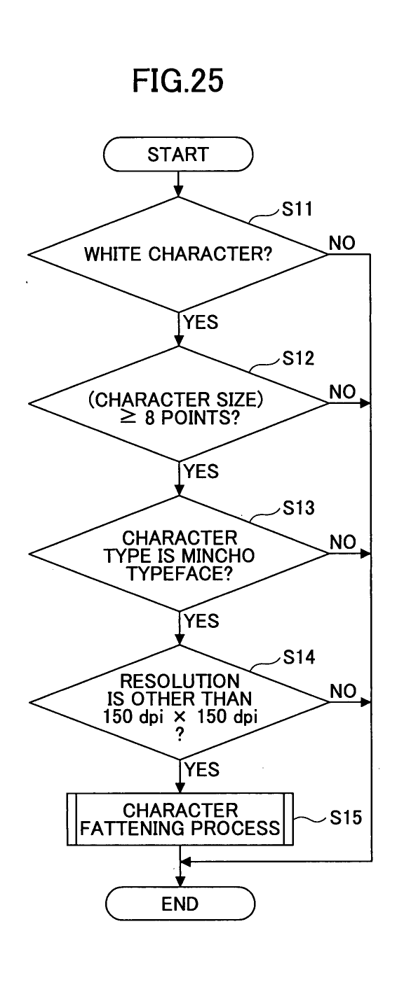

Next, a description will be given of a process which switches between the mode in which the character fattening process is carried out and the normal mode in which no character fattening process is carried out, depending on the character size, the character type, the image resolution, the color of the peripheral dots in the periphery of the white character, and the like, by referring to FIG. 25. FIG. 25 is a flow chart for explaining this process of switching between the mode that carries out the character fattening process depending on the character size, the character type, the resolution and the like, and the normal mode that does not carry out the character fattening process.

In the process shown in FIG. 25, the character fattening process is carried out when the character size of the white character is 8 points or greater, the character type of the white character is the Mincho typeface, and the image resolution of the white character is other than 150 dpi in both the main and sub scanning directions. Of course, the judging conditions related to the character size, the character type and the image resolution are of course not limited to those shown in FIG. 25.

In FIG. 25, a step S11 decides whether or not the character is a white character. If the decision result in the step S11 is YES, a step S12 decides whether or not the character size is 8 points or greater. If the decision result in the step S12 is YES, a step S13 decides whether or not the character type is the Mincho typeface. If the decision result in the step S13 is YES, a step S14 decides whether or not the image resolution of the character is other than 150 dpi in both the main and sub scanning directions. If the decision result in the step S14 is YES, a step S15 carries out the character fattening process described above. On the other hand, if the decision result is NO in one of the steps S11 through S14 or, after the step S15, the process ends.

In addition, if the color of the peripheral dots in the periphery of the white character has the second color or more, that is, the ink drops of two or more colors are ejected with respect to one pixel corresponding to the peripheral dot, it is possible to carry out the character fattening process with respect to the white character because the feathering or bleeding more easily occurs in such a case. Of course, the character fattening process may be carried out with respect to the white character when the background portion is formed by dots having a single first (or primary) color such as black, magenta and cyan. If the single first (or primary) color forming the background portion is yellow, it is possible not to carry out the character fattening process with respect to the white character because the background itself becomes conspicuous in such a case. In other words, the mode in which the character fattening process is carried out and the normal mode in which no character fattening process is carried out may be selected (or switched) depending on the color of the peripheral dots in the periphery of the white character.

Therefore, by selecting or switching between the mode in which the character fattening process is carried out (mode in which the blank dots are added) and the normal mode in which no character fattening process is carried out (mode in which no blank dots are added) depending on the character size, the character type, the image resolution and the color of the peripheral dots, it is possible to obtain a high PPM output without requiring an unnecessarily high processing speed even when obtaining a high throughput.

In the image forming apparatus of this embodiment, the recording head is a piezoelectric head using a piezoelectric element. However, as described above, the recording head may of course be a thermal head which uses an electro-thermal conversion element to eject the ink drop by film boiling. In the case of the piezoelectric head, the ink drops having different sizes can be ejected depending on the driving signal waveform, as described above, and it is possible to easily form a gradation image. On the other hand, in the case of the thermal head, the nozzles can be arranged at a high density, and it is possible to print an image having a high resolution at a high speed.

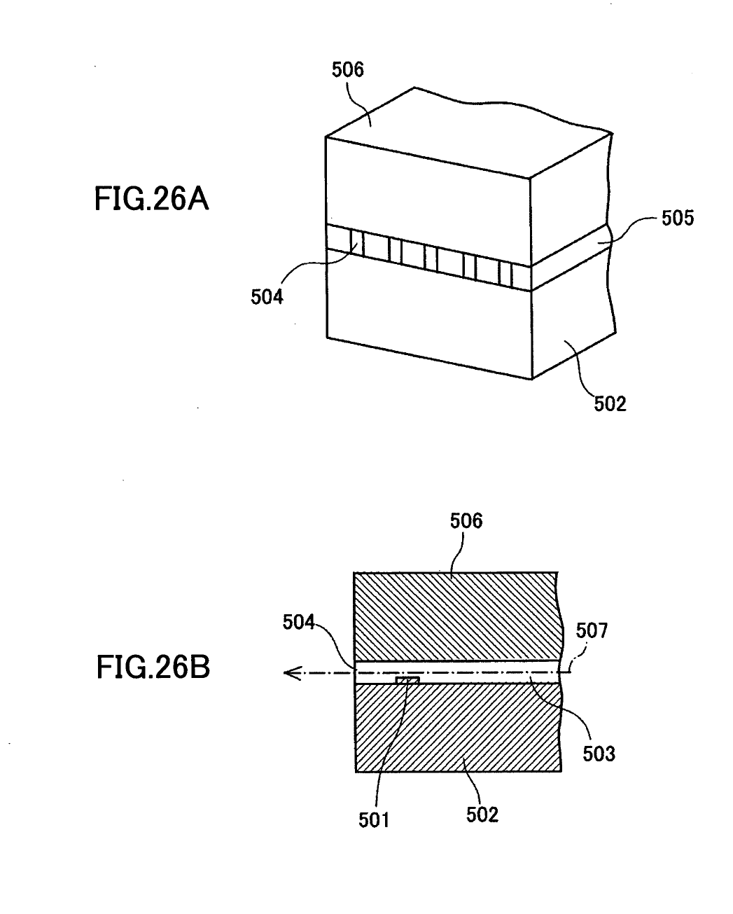

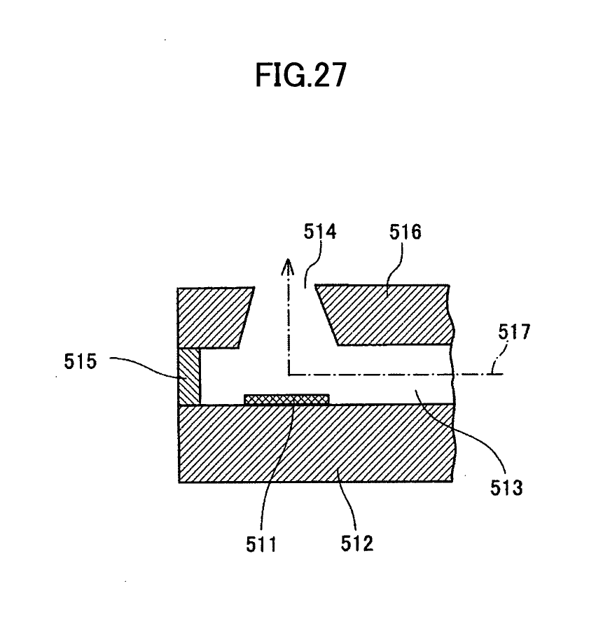

A description will be given of different thermal heads, by referring to FIGS. 26A and 26B and FIG. 27.

FIGS. 26A and 26B respectively are a perspective view and a cross sectional view for explaining another structure of the recording head, namely, an edge shooter type thermal head. The edge shooter type thermal head shown in FIGS. 26A and 26B has a stacked structure made up of a substrate 502, an ink-jet energy generating body 501, a wall member 505 that forms side walls of flow passages 503 and nozzles 504, and a top plate 506 that covers the flow passages 503. In FIG. 26B, the illustration of electrodes of the ink-jet energy generating body 501 to which the recording signal (or ink-jet signal) is applied and the illustration of a protection layer which is provided on the ink-jet energy generating body 501 if necessary, are omitted for the sake of convenience. As indicated by a one-dot chain line 507 in FIG. 26B, the ink flows straight from the flow passage 503 towards the nozzle 504 in this edge shooter type thermal head.

In a state where the ink from an ink chamber (not shown) fills the flow passage 503, a recording signal is applied to the ink-jet energy generating body 501 via the electrodes (not shown). The ink-jet energy generated from the ink-jet energy generating body 501 acts on the ink within the flow passage 503 at the upper portion (ink-jet energy acting portion) of the ink-jet energy generating body 501, and as a result, the ink drop is ejected from the nozzle 504.

In the case of the edge shooter type thermal head, it is possible to form the various parts of the head extremely small with a high precision, and the nozzles can be made small and a large number of nozzles can be formed with ease. Accordingly, the edge shooter type thermal head is suited for mass production. On the other hand, there are limits to increasing the response frequency when the ink drop is ejected and the ink-jet speed of the ink drop. In addition, air bubbles are generated within the ink when the electro-thermal conversion element generates heat, but the air bubbles contract when the temperature drops. Hence, the so-called cavitation phenomenon occurs in which the ink-jet energy generating body 501 is gradually damaged by the shock of the air bubbles disappearing in the vicinity of the ink-jet energy generating body 501, thereby making the serviceable life of the edge shooter type thermal head relatively short.

FIG. 27 is a cross sectional view for explaining still another structure of the recording head, namely, a side shooter type thermal head. The side shooter type thermal head shown in FIG. 27 has a stacked structure made up of a substrate 512, an ink-jet energy generating body 511, a flow passage forming member 515 that forms side walls of a flow passage 513, and a nozzle plate 516 having a nozzle 514. In FIG. 27, the illustration of electrodes of the ink-jet energy generating body 511 to which the recording signal (or ink-jet signal) is applied and the illustration of a protection layer which is provided on the ink-jet energy generating body 511 if necessary, are omitted for the sake of convenience. As indicated by a one-dot chain line 517 in FIG. 27, the direction in which the ink flows towards an ink-jet energy acting portion within the flow passage 513 is perpendicular to a center axis of an aperture forming the nozzle 514 in this side shooter type thermal head.

In this side shooter type thermal head, the energy from the ink-jet energy generating body 511 can be converted mode efficiently to the formation of the ink drop and the kinetic energy of the ejected ink drop. In addition, the meniscus is restored quickly by the ink supply, due to the structure of the side shooter type thermal head. Therefore, the side shooter type thermal head is particularly effective when a heating element is used for the ink-jet energy generating body 511. Moreover, the side shooter type thermal head can avoid the so-called cavitation phenomenon in which the ink-jet energy generating body is gradually damaged by the shock of the air bubbles disappearing in the vicinity of the ink-jet energy generating body. In other words, in the case of the side shooter type thermal head, when the air bubbles grow and reach the nozzle 514, the air bubbles communicate to the atmosphere and the contraction of the air bubbles due to the temperature drop will not occur, to thereby make the serviceable life of the side shooter type thermal head relatively long.

In the embodiment described heretofore, the image processing apparatus is designed so that the printer driver forming the computer-readable program according to the present invention executes the image processing method according to the present invention. However, the image forming apparatus itself may be provided with means for executing the image processing method according to the present invention. In addition, it is also possible to provide within the image forming apparatus an application specific integrated circuit (ASIC) which executes the image processing method according to the present invention.

### Second Embodiment

When creating a document by an application software and outputting the document from an image forming apparatus such as an ink-jet recording apparatus (or ink-jet printer) that forms the image by arranging dots, the font (generally, a true type font) that is specified by the application software is converted by the application software or a printer driver into the character data formed by the dots to be output from the image forming apparatus.

In this case, depending on the application software or the printer driver, the width (or degree of fatness) of the character that is output may become narrow (or thin). It may be regarded that, when forming the contour portion of the true type font, it is impossible to truly reproduce the character contour depending on the printing resolution.

In addition, the width (or degree of fatness) of the character is relatively wide (or fat) in the case of the Gothic typeface, but is relatively narrow (or thin) in the case of the Mincho typeface. In other words, the width (or degree of fatness) of the character depends on the character type. For this reason, when the document is created in the Mincho typeface, there are cases where it is desirable to output the document with a typeface having a width (or degree of fatness) that is wider (of fatter) so as to make the character more easily readable or recognizable.

In such cases, there is a process that fattens the specified character using a fatface or boldface function of the application software. But when the character is fattened by the process using the fatface or boldface function, the character is normally fattened by several dots or more. For this reason, the character is converted into a character having a width (or degree of fatness) that is clearly different from the original character, and if the process is carried out with respect to all of the characters within the document, the document as a whole may become difficult to read.

Accordingly, a description will now be given of a second embodiment of the present invention which can improve the picture quality by slightly fattening the image when the output image is too thin.

In this second embodiment of the present invention, if an image to be formed on a recording medium is too thin, a fattening process is carried out to fatten the image by adding dots to a blank background portion that is adjacent to dots forming the image.

It is preferable that the image that is subjected to the fattening process is a character image which is in black or a color other than the background color, such as white or the color of the recording medium. In this case, if the image to be formed on the recording medium includes a black character which is in black or a color other than white, for example, a fattening process is carried out to fatten the black character by adding image dots to a blank background portion that is in white or a color close to white and is adjacent to image dots forming the black character. The black character is in black or, a color other than the color of the recording medium itself or, a color other than a color that is formed on the recording medium as a base color. In addition, the adding of the image dots to the blank background portion includes replacing the blank dots of the blank background portion by the image dots.

It is preferable to judge whether or not a dot is to be added with the image dot based on a pattern matching between an m×n window which includes a target pixel and a predetermined pattern. In this case, the pattern matching is preferably applied to the blank background portion of the image, and the image dot is added depending on a result of the pattern matching.

It is preferable that the image dot (or black dot) that is added to the blank background portion has a relatively small size. In addition, the pattern matching may be carried out using the image dot of the image portion and the blank dot of the blank background portion as the target pixel, so as to add the image dot having the small size depending on the result of the pattern matching.

The image dots that are added may have a plurality of sizes. In this case, the size of the image dots that are added may be different depending on the inclination (or slope) of the contour portion of the image.

Furthermore, it is preferable that a selection or switching is possible between a mode which adds the image dots and a mode which does not add the image dots. In the case of the character image, the selection or switching between the two modes may be made depending on the character size, the kind of character and the resolution of the image.

An image forming apparatus of this embodiment outputs the image data generated by the image processing method of this embodiment. The image forming apparatus is provided with a recording head having pressure generating means for generating an energy that applies pressure to a pressure chamber to which a nozzle for ejecting an ink drop communicates, and driving waveform generating means for generating a driving signal waveform having a plurality of driving pulses within one recording period (or printing period) for driving the pressure generating means of the recording head. The driving signal waveform has the plurality of driving pulses that are selected so that a plurality of ink drops ejected in response to the plurality of driving pulses are combined during flight into a single ink drop that lands the recording medium. Furthermore, of the plurality of driving pulses that are selected, the last driving pulse makes the ink-jet speed of the ink drop relatively low. The image dots are formed in the blank background portion adjacent to the image dots forming the image by using such selected driving pulses.

It is preferable that the driving signal waveform is set so that the ink drops having different sizes land at approximately the same position on the recording medium. In addition, it is preferable that the driving signal waveform includes a waveform element that causes the volume of the pressure chamber to expand so as to draw the meniscus towards the pressure chamber, and a waveform element that causes the volume of the expanded pressure chamber to contract. The waveform element that causes the volume of the pressure chamber to expand, formed by the last driving pulse of the plurality of driving pulses, may have a relatively low voltage so that the ink-jet speed becomes relatively low.

Of the plurality of driving pulses that are output within one recording period, it is preferable that different combinations of two or more driving pulses are selectable depending on the recording signal. Furthermore, it is preferable that the driving signal waveform includes a micro driving pulse that vibrates the meniscus without ejecting the ink drop from the recording head. In this case, it is preferable for the relationship of the micro driving pulse and the driving pulse which follows to be such that the volume of the ink drop ejected from the recording head in response to the micro driving pulse and the following driving pulse is large relative to a case where no micro driving pulse precedes the driving pulse.

It is preferable that the driving signal waveform applied to the pressure generating means includes at least a driving pulse for forming a large ink drop, a driving pulse for forming a small ink drop, and the micro driving pulse. Moreover, the viscosity of the ink is preferably in a range of 5 mPa·s to 20 mPa·s.

According to this embodiment, it is possible to improve the picture quality of the image such as a character image, by slightly fattening the image when the output image is too thin so as to improve the readability and recognizability of the character or the like, by adding the image dots at suitable positions in the blank background portion. Moreover, a high-resolution image can be formed at a high speed, particularly when the recording head ejects the ink by film boiling.

A description will now be given of this second embodiment of the present invention. First, a description will be given of the image forming apparatus which outputs image data generated by the image processing method in this second embodiment of the present invention. The basic structure and operation of the image forming apparatus of this second embodiment are the same as those of the image forming apparatus of the first embodiment described above in conjunction with FIGS. 1 through 11, and a description thereof will be omitted.

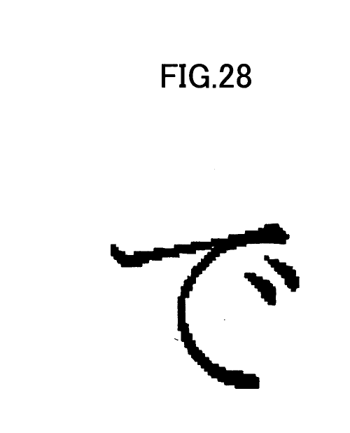

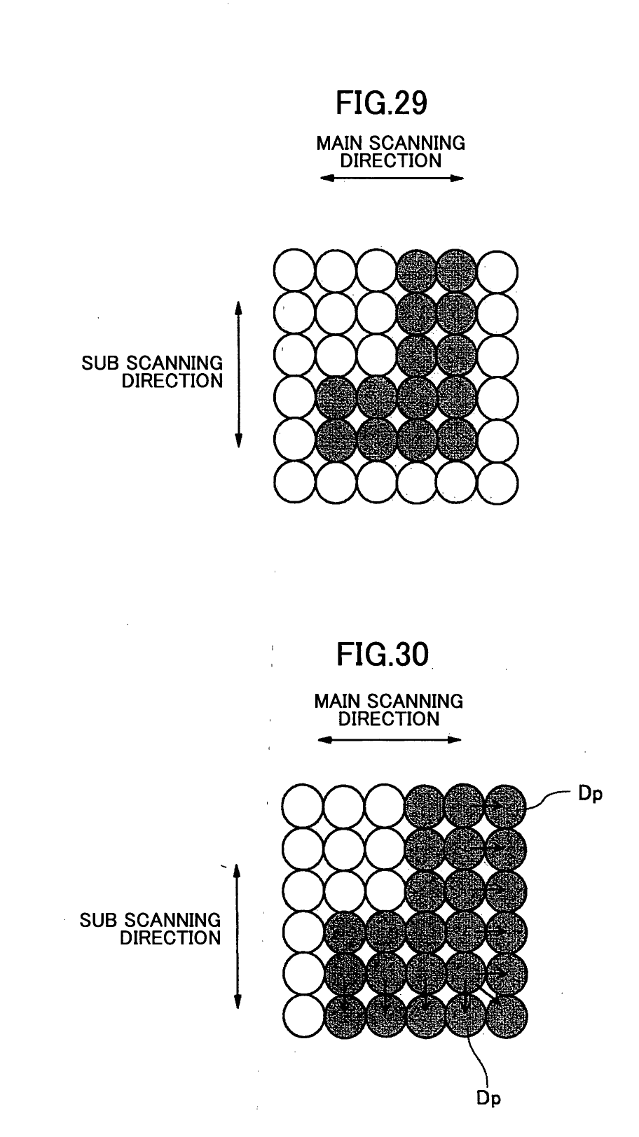

A description will now be given of a process of fattening the image, such as a black character, by referring to FIG. 28 and the subsequent figures. FIG. 28 is a diagram showing a black character that is formed by a comparison example which does not carry out the character fattening process, and FIG. 29 is a diagram showing dots of an important part on an enlarged scale, for explaining the black character that is formed by this comparison example.

As shown in FIG. 29, the resolution of the image in the sub scanning direction is 300 dpi, for example, and is the same as the nozzle pitch. The resolution of the image in the main scanning direction is 600 dpi, for example, which is two times the resolution in the sub scanning direction. For the sake of convenience, FIG. 29 shows image portions of the black character by black circular marks, and shows background portions by white circular marks. This means that the ink drop lands on the black circular marks, to thereby form the black character. The image portions of the black character and the blank background portions are illustrated similarly in each of FIGS. 30, 31, 35A through 35C, 36A, 36B, 38A through 38E, 39A, 39B, 40 through 47, 51A and 51B which will be described later. Since the resolution in the main scanning direction is two times that in the sub scanning direction, two dots in the main scanning direction correspond to one dot in the sub scanning direction, but for the sake of convenience, FIG. 29 shows the main scanning direction on a scale that is enlarged to two times the scale of the sub scanning direction, and the main and sub scanning directions are illustrated similarly in each of the figures which will be described later.

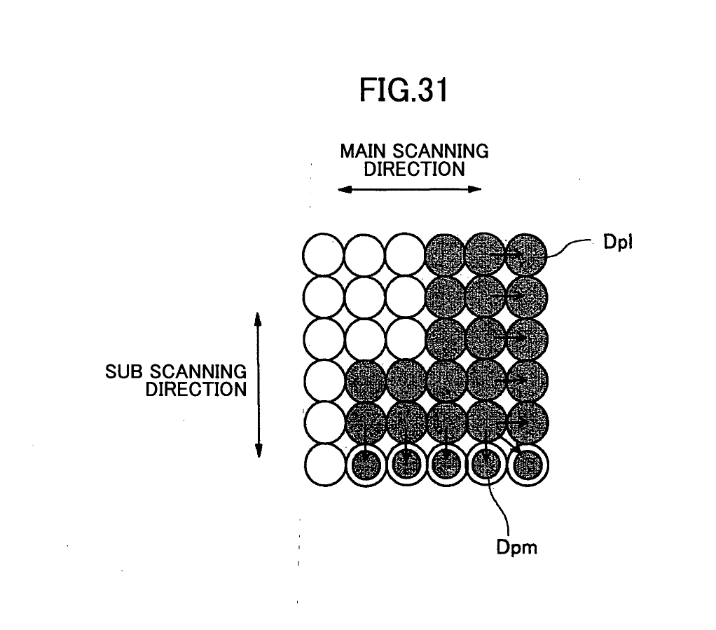

FIG. 30 is a diagram showing a black character that is formed by carrying out the character fattening process in this second embodiment of the present invention, and FIG. 31 is a diagram showing dots of an important part on an enlarged scale, for explaining the black character that is formed by carrying out the character fattening process. As shown in FIG. 30, one large ink drop (large dot) Dp is added in the main scanning direction with respect to each dot (indicated by the white circular mark) forming the blank background portion and located on the side (right side in FIG. 30) opposite to the side (left side in FIG. 30) adjacent to the dot (indicated by the black circular mark) forming the image portion of the black character, and one large ink drop (large dot) Dp is added in the sub scanning direction with respect to each dot (indicated by the white circular mark) forming the blank background portion and located on the side (lower side in FIG. 30) opposite to the side (upper side in FIG. 30) adjacent to the dot (indicated by the black circular mark) forming the image portion forming the black character. As a result, at the boundary of the dots forming the blank background portion and the dots forming the black character, the dots forming the blank background portion decrease by an amount the dots forming the black character increases by the character fattening process. The picture quality of the black character is improved by the character fattening process.

FIG. 31 is a diagram showing dots of an important part on an enlarged scale, for explaining a black character that is formed by another character fattening process in the second embodiment of the present invention. FIG. 31 shows a case where the resolution is relatively high, namely, 600 dpi in the main scanning direction, and the resolution is relatively low, namely, 300 dpi in the sub scanning direction. In this case, as shown in FIG. 31, one large ink drop (large dot) Dp1 is added in the main scanning direction with respect to each dot (indicated by the white circular mark) forming the blank background portion and located on the side (right side in FIG. 31) opposite to the side (left side in FIG. 31) adjacent to the dot (indicated by the black circular mark) forming the image portion of the black character, and one medium ink drop (medium dot) Dpm is added in the sub scanning direction with respect to each dot (indicated by the white circular mark) forming the blank background portion and located on the side (lower side in FIG. 31) opposite to the side (upper side in FIG. 31) adjacent to the dot (indicated by the black circular mark) forming the image portion of the black character. As a result, at the boundary of the dots forming the blank background portion and the dots forming the black character, the dots forming the blank background portion decrease by an amount the dots forming the black character increases by the character fattening process, and the picture quality of the black character is improved by the character fattening process.

Since the image forming apparatus of this embodiment can form the large, medium and small ink drops (or large, medium and small dots), it is of course possible to add a small ink drop in place of the medium ink drop.

By changing the size of the ink drop (that is, the dot size) depending on the resolution as shown in FIG. 31, it is possible to suitably fatten the black character even in a case where the resolution is relatively low and the addition of the large dot would excessively fatten the black character.

Next, a more detailed description will be given on the character fattening process with respect to the black character.

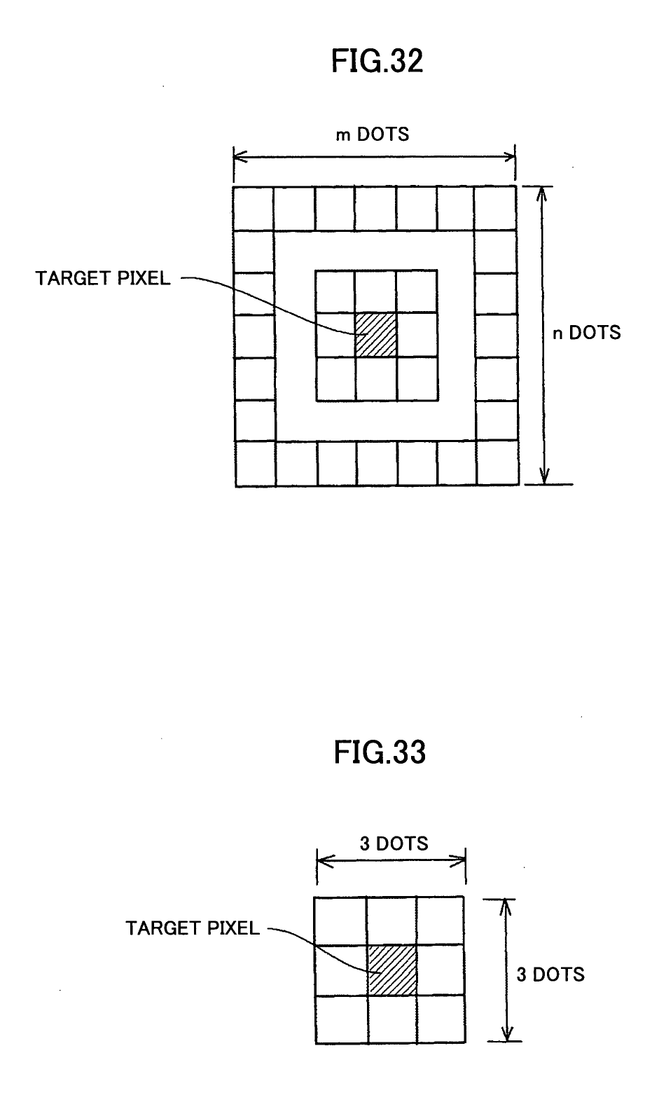

As one method of adding the large dot on the right or left side and on the lower side of the dot in the image portion forming the black character, the pattern matching is suited from the point of view of carrying out the process at a high speed. FIG. 32 is a diagram for explaining a window size used for the pattern matching. FIG. 32 shows an m×n window having m pixels arranged horizontally and n pixels arranged vertically. In the following description, it is assumed for the sake of convenience that m=n and the window size is m×n=3×3, that is, m=3 and n=3 as shown in FIG. 33. FIG. 33 is a diagram for explaining the 3×3 window size.

The font data is developed into the bit-map data by the printer driver (software). The bit-map data indicates the dots forming the font. The bit-map data, indicating the font data, is subjected to the pattern matching in units of the window W described above, for each bit.

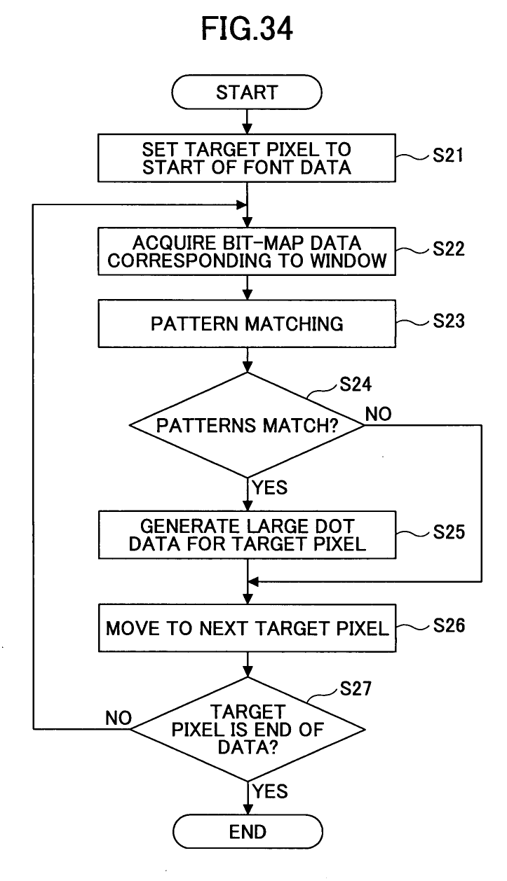

A description will be given of the pattern matching process, that is, the character fattening process, carried out by the printer driver 101A, by referring to FIG. 34. FIG. 34 is a flow chart for explaining the character fattening process (pattern matching process).

First, a step S21 sets a target pixel to a start of the font data. A step S22 acquires the bit-map data of the font data corresponding to the window W, by using the target pixel as the center of the window W. Hence, the acquired bit-map data corresponds to the data amounting to 3×3=9 dots.

Thereafter, a step S23 carries out a pattern matching by comparing the acquired bit-map data (pattern of the acquired data) and a predetermined reference data (reference pattern) which is set in advance and is used to add the dots. A step S24 decides whether or not the compared patterns match. The process advances to a step S25 if the decision result in the step S24 is YES, and the process advances to a step S26 if the decision result in the step S24 is NO.

The step S25 generates the large dot data (or the medium dot data) for the target pixel, so as to replace the dot of the target pixel by the large dot (or the medium dot). The process advances to the step S26 after the step S25.

The step S26 moves to a next target pixel. In addition, a step S27 decides whether or not the target pixel is the end of data. The process returns to the step S22 if the decision result in the step S27 is NO, so as to repeat the pattern matching until the end of data. On the other hand, the process ends if the decision result in the step S27 is YES.

The process shown in FIG. 34 may treat one pixel as a 1-byte data or, a 1-bit data. When treating one pixel as a 1-byte data, 9 bytes are required to represent data amounting to 9 dots. On the other hand, when treating one pixel as a 1-bit data, only 2 bytes are required to represent data amounting to 9 dots. Hence, the amount of data to be processed is small when one pixel is treated as a 1-bit data, and the required memory capacity can be reduced and the processing speed can be improved in this case.

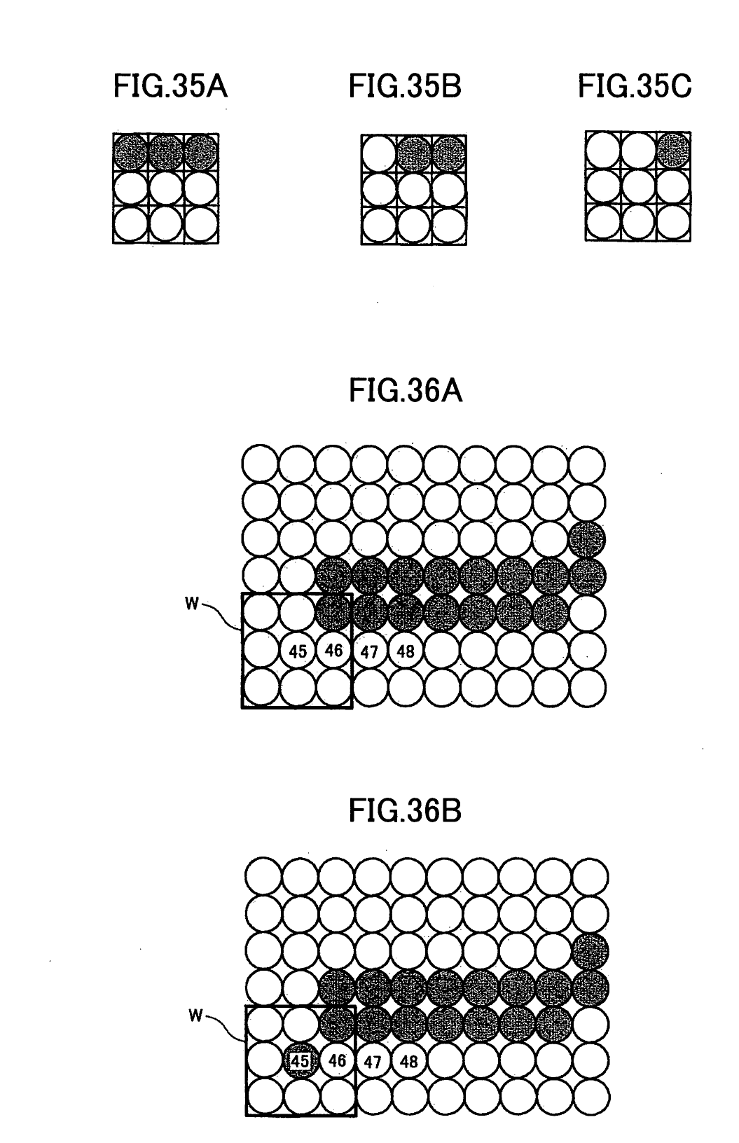

FIGS. 35A through 35C are diagrams for explaining reference patterns of the 3×3 window size used in the character fattening process, and FIGS. 36A and 36B are diagrams for explaining the use of the reference patterns shown in FIGS. 35A through 35C.

When the pattern matching is made with respect to the font data shown in FIG. 36A using the reference patterns shown in FIGS. 35A through 35C, the state of the dots included in a window W having a pixel position (or dot position) 45 of the font data as a target pixel becomes as shown in FIG. 36A, and matches the reference pattern shown in FIG. 35C. Hence, in this case, the blank data of the target pixel 45 is replaced by a dot data (image dot data), as shown in FIG. 36B.

Similarly, when the window W moves by one pixel (or dot) to the right in FIG. 36A, the state of the dots included in the window W having a pixel position (or dot position) 47 of the font data as the target pixel matches the reference pattern shown in FIG. 35A. Hence, in this case, the blank data of the target pixel 47 is replaced by a dot data (image dot data).

Because the black character is being recorded, the dots added to the blank background portion adjacent to the dots of the black character are recorded (that is, are image dot data). When generating the dot data, the print data represented by “0” is changed to “255” representing the image dot data if the original font data is represented by “0” (blank) or “255” (print data) as in the case of the bit-map data. The print data represented by “0” is changed to “1” representing the image dot data if the original font data is represented by “0” (blank) or “1” (print data) as in the case of binary (or bi-level) data.

It is possible to fatten the black character by printing the large (or medium or small) dots depending on the font data formed by the data indicating the large dots generated by the pattern matching (in the case of the bit-map data) or, the font data of the original binary data (“0” or “1”) and the binary data (“0” or “1”) of the small dots (in the case of the binary data).

It is assumed in FIGS. 36A and 36B that the large dot is added in the sub scanning direction as in the case shown in FIG. 30. However, when adding the medium dot (or small dot) in the sub scanning direction and adding the large dot in the main scanning direction as in the case shown in FIG. 31, the reference patterns are created independently for the sub scanning direction and the main scanning direction. In this case, the pattern matching is made similarly as described above for the main scanning direction using the reference patterns for the main scanning direction and for the sub scanning direction using the reference patterns for the sub scanning direction, so as to add (replace the blanks) by dots having different sizes.

Next, a description will be given of another character fattening process which also carries out a jaggy correction with respect to a step (or staircase) change.

As the method of adding the small, medium or large dot to the side or below the dot forming the black character, the pattern matching process is convenient in that the process of adding the dots can be carried out at a high speed. The window size used for the pattern matching process is m×n, that is, m pixels in the horizontal direction and n pixels in the vertical direction. But when carrying out the jaggy correction with respect to an oblique line that is close to a direction parallel to the main scanning direction and not carrying out the jaggy correction with respect to an oblique line that is close to a direction parallel to the sub scanning direction, m and n take different values. In other words, m is set to a large value so that a transition point of the step (or staircase) change in the oblique line close to the horizontal line and blanks (blank dots) in the vicinity of this transition point can be detected. On the other hand, since it is unnecessary to detect the vicinity of the transition point of the step change in the oblique line close to the vertical line need not be detected, n is set to a small value. In this particular case, the window size m×n=9×3 by setting m=9 and n=3.

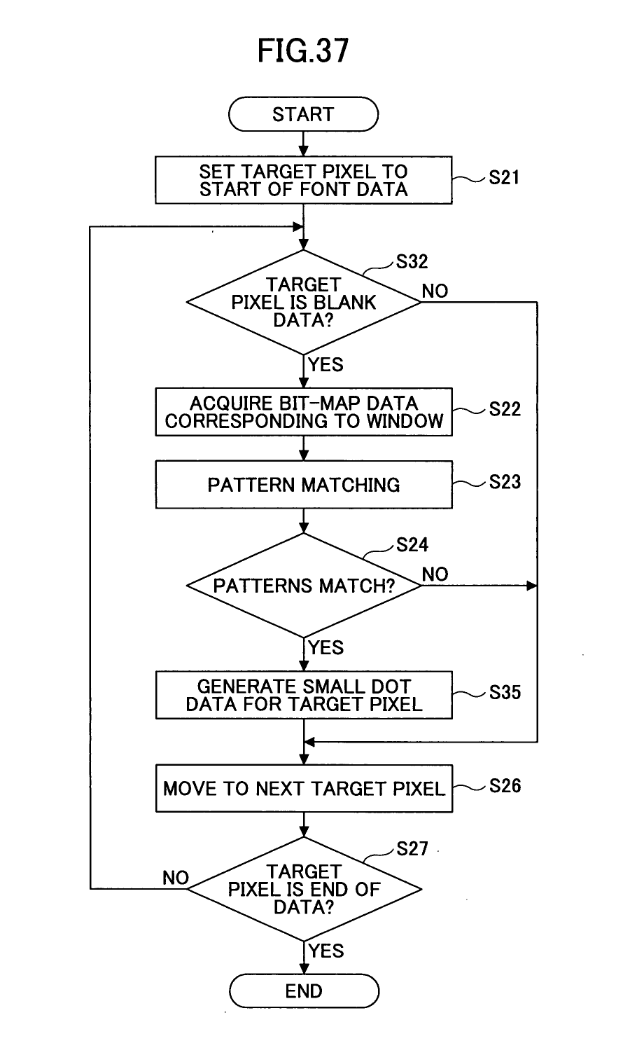

FIG. 37 is a flow chart for explaining this other character fattening process which also carries out the jaggy correction. In FIG. 37, those steps that are the same as those corresponding steps in FIG. 34 are designated by the same reference numerals, and a description thereof will be omitted.

In FIG. 37, a step S32 is provided between the steps S21 and S22, and a step S35 is provided in place of the step S25 shown in FIG. 34. The step S32 decides whether or not the target pixel is blank data. The process advances to the step S26 if the decision result in the step S32 is NO. On the other hand, the process advances to the step S22 if the decision result in the step S32 is YES, and the step S22 acquires the bit-map data amounting to 9×3=27 dots. The step S23 carries out the pattern matching by comparing the acquired bit-map data (pattern of the acquired data) and a predetermined reference data (reference pattern) which is set in advance and is used to add the small dots or replace the blank by the small dots. The step S35 generates the small dot data for the target pixel, so as to replace the dot of the target pixel by the small dot. The process advances to the step S26 after the step S35.

The process shown in FIG. 37 may treat one pixel as a 1-byte data or, a 1-bit data. When treating one pixel as a 1-byte data, 27 bytes are required to represent data amounting to 27 dots. On the other hand, when treating one pixel as a 1-bit data, only 4 bytes are required to represent data amounting to 27 dots. Hence, the amount of data to be processed is small when one pixel is treated as a 1-bit data, and the required memory capacity can be reduced and the processing speed can be improved in this case.

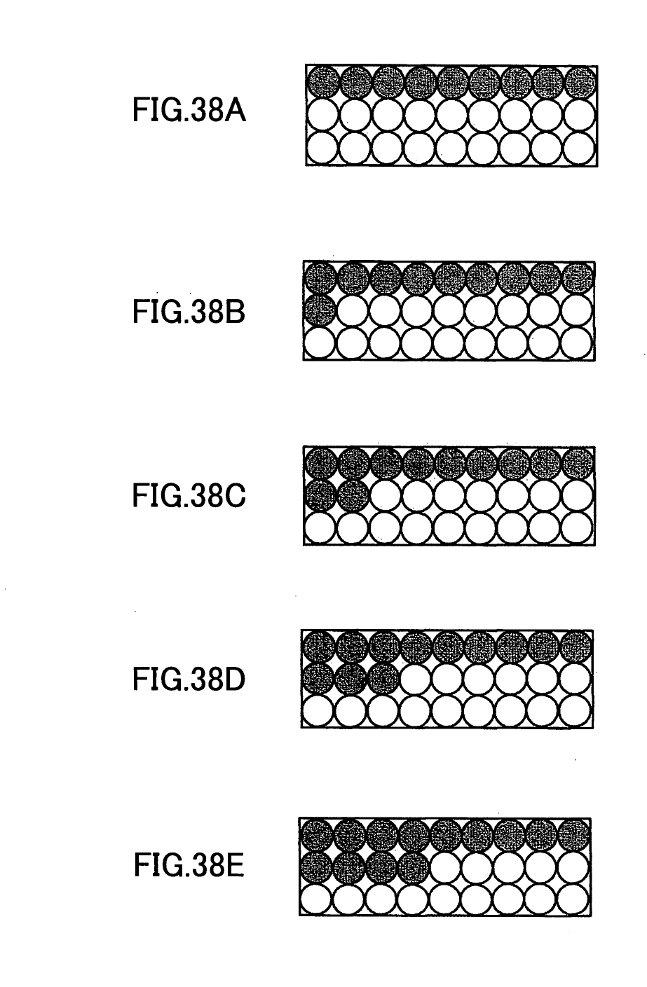

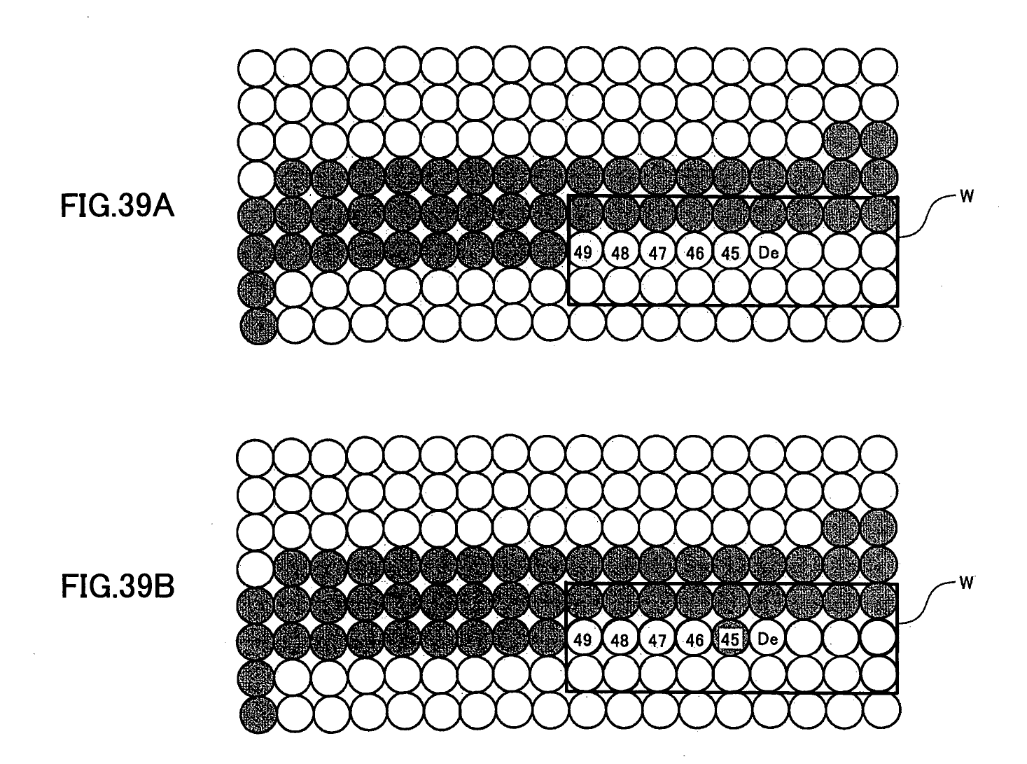

Next, a description will be given of a pattern matching process which only carries out the jaggy correction, by referring to FIGS. 38A through 38E and FIGS. 39A and 39B. FIGS. 38A through 38E are diagrams for explaining reference patterns of the 9×3 window size used in the character fattening process, and FIGS. 39A and 39B are diagrams for explaining the use of the reference patterns shown in FIGS. 35A through 35C.

When the pattern matching is made with respect to the font data shown in FIG. 39A using the reference patterns shown in FIGS. 38A through 38E, the state of the dots included in a window W having a pixel position (or dot position) 45 of the font data as a target pixel becomes as shown in FIG. 39A, and matches the reference pattern shown in FIG. 38A. Hence, in this case, the blank data of the target pixel 45 is replaced by a dot data indicating a small dot, as shown in FIG. 39B.

In this case, when generating the dot data for the small dot (small ink drop), the print data represented by “0” is changed to “255” representing the image dot data if the original font data is represented by “0” (blank) or “255” (print data) as in the case of the bit-map data, and the changed print data “255” is then replaced by data “85” representing the small dot, for example, and the print data represented by “0” is changed to “1” representing the image dot data if the original font data is represented by “0” (blank) or “1” (print data) as in the case of binary (or bi-level) data, and the changed print data “1” is then replaced by data representing the small dot in a similar manner. Alternatively, when processing the binary data “0” and “1” as they are, a separate memory having the same size as the font data is provided for the print data representing the small dot, and the print data is set to “1” with respect to the pixel position within this separate memory representing the small dot. Therefore, it is possible to fatten the black character by recording the font data formed by the data representing the small dots generated by the pattern matching and the data representing the large dots in the first case or, by recording the font data formed by the binary data (“0” and “1”) representing the small dots and the original binary font data (“0” and “1”) in the latter case.

By using the 9×3 window size for the window W and the reference patterns, it is possible to judge whether or not to replace the total of 4 blank dots before and after the transition point by the small image dot. If all of the dots (both blank and image dots) are regarded as the target pixel, it is possible to judge whether or not to replace the total of 4 dots, including the blank and image dots), before and after the transition point by the small image dot. The 4 dots before and after the transition point is replaced by the small image dot because the transition point falls outside the window W if a pixel position (dot position) De in FIG. 39A is the target pixel, in which case the transition point cannot be detected. In order to add the small image dot even at the pixel position De, the 9×3 window size needs to be used for the window W and the reference patterns.

In other words, by increasing the window sizes of the window W and the reference patterns, it becomes possible to detect the transition point of the oblique line close to the horizontal or vertical line, and to add the small image dot depending on the inclination of the oblique line, so as to optimize the picture quality of the oblique line.

Of course, the window sizes of the reference patterns and the window W are not limited to those described above, and may be determined depending on the extent to which the replacement to the image dots is to be made and whether or not the processing time is quick enough to cope with the printing speed. Because the amount of data to be compared by the pattern matching process increases as the window sizes of the reference patterns and the window W increase, the time required to carry out the pattern matching process increases as the window sizes of the reference patterns and the window W increase. Hence, from the point of view of reducing the processing time, it is desirable that the window sizes of the reference patterns and the window W are small. On the other hand, the number of dots in the vicinity of the transition point to be replaced by the image dots is determined by the picture quality of the character obtained by the jaggy correction. Therefore, it is necessary to determine the optimum window sizes of the window W and the reference patterns based on the processing speed and the picture quality of the character.

According to experiments conducted by the present inventors, it was found that a sufficient improvement of the picture quality of the character can be obtained even by adding 4 image dots or, more preferably 6 image dots, because in the case of the above described ink used in this embodiment, the jaggy between the adjacent dots is reduced by the spreading of the ink. Furthermore, it was also found that a sufficient improvement of the processing speed can be obtained, and that a throughput of 10 PPM or greater is obtainable. Thus, the window size is preferably set to m=13 or greater that enables the detection of the 6 dots in the main scanning direction and n=3 in the sub scanning direction.

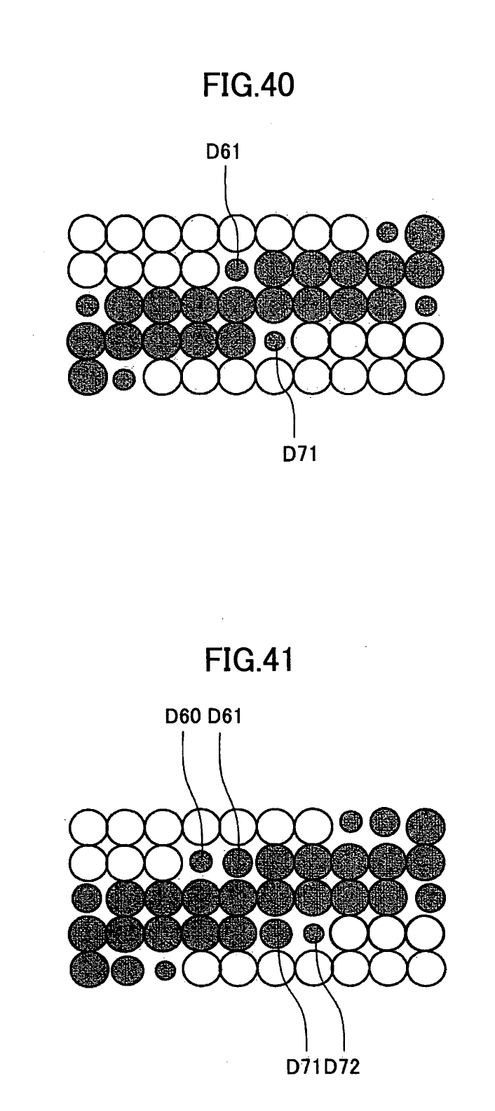

Next, a description will be given of other character fattening processes using other jaggy corrections, by referring to FIGS. 40 through 47. First through eighth jaggy corrections used in FIGS. 40 through 47 use two kinds of image dot sizes, namely, the small dot and the medium dot, in place of the small dot that is added in the jaggy correction described above, and also add different number of dots. In FIGS. 40 through 47, the actual dot pitch (separation of two mutually adjacent dots) is 600 dpi in the main scanning direction and 300 dpi in the sub scanning direction.

FIG. 40 is a diagram for explaining a character fattening process using a first jaggy correction. FIG. 40 shows a case where 1 small image dot is added to 1 blank dot before the transition point, at the pixel positions D61 and D71.

FIG. 41 is a diagram for explaining a character fattening process using a second jaggy correction. FIG. 41 shows a case where 1 medium image dot and 1 small image dot are added to 2 blank dots before the transition point, at the pixel positions D61 and D71 for the medium image dots and at the pixel positions D60 and D70 for the small image dots.

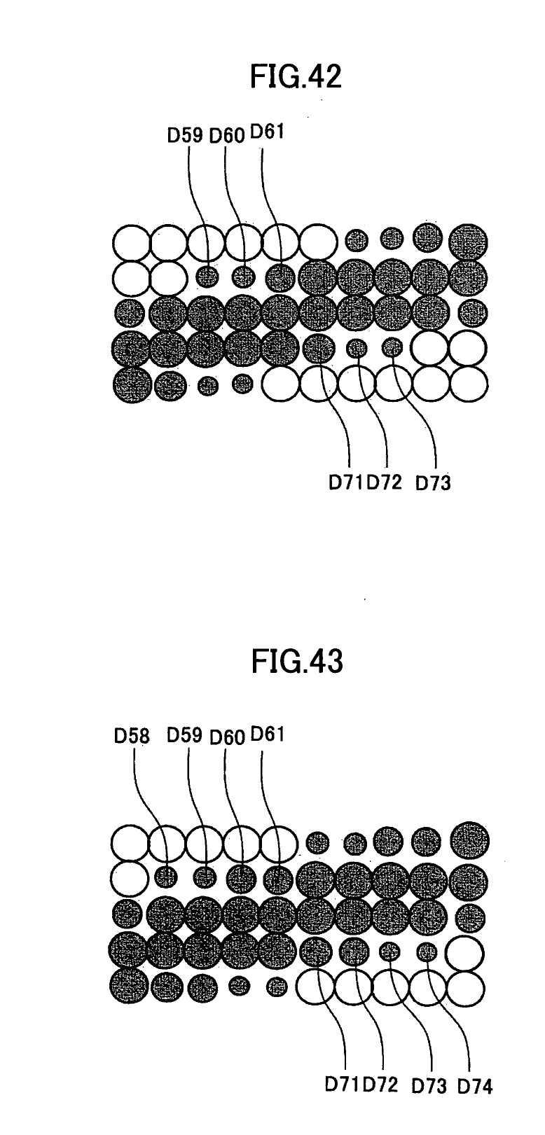

FIG. 42 is a diagram for explaining a character fattening process using a third jaggy correction. FIG. 42 shows a case where 1 medium image dot and 2 small image dots are added to 3 blank dots before the transition point, at the pixel positions D61 and D71 for the medium image dots and at the pixel positions D59, D60, D72 and D73 for the small image dots.

FIG. 43 is a diagram for explaining a character fattening process using a fourth jaggy correction. FIG. 43 shows a case where 2 medium image dots and 2 small image dots are added to 4 blank dots before the transition point, at the pixel positions D60, D61, D71 and D72 for the medium image dots and at the pixel positions D58, D59, D73 and D74 for the small image dots.

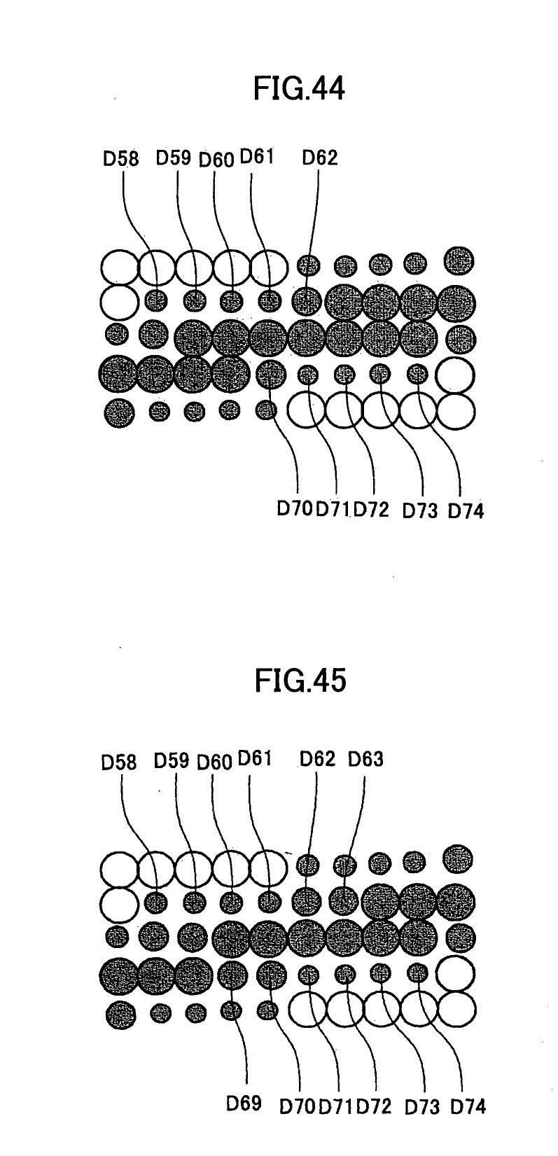

FIG. 44 is a diagram for explaining a character fattening process using a fifth jaggy correction. FIG. 44 shows a case where 4 small image dots are added to 4 blank dots before the transition point at the pixel positions D58 through D61 and D71 through D74, and 1 medium image dot replaces 1 image dot after the transition point at the pixel positions D62 and D70.

FIG. 45 is a diagram for explaining a character fattening process using a sixth jaggy correction. FIG. 45 shows a case where 4 small image dots are added to 4 blank dots before the transition point at the pixel positions D58 through D61 and D71 through D74, and 2 medium image dots replace 2 image dots after the transition point at the pixel positions D62, D63, D69 and D70.

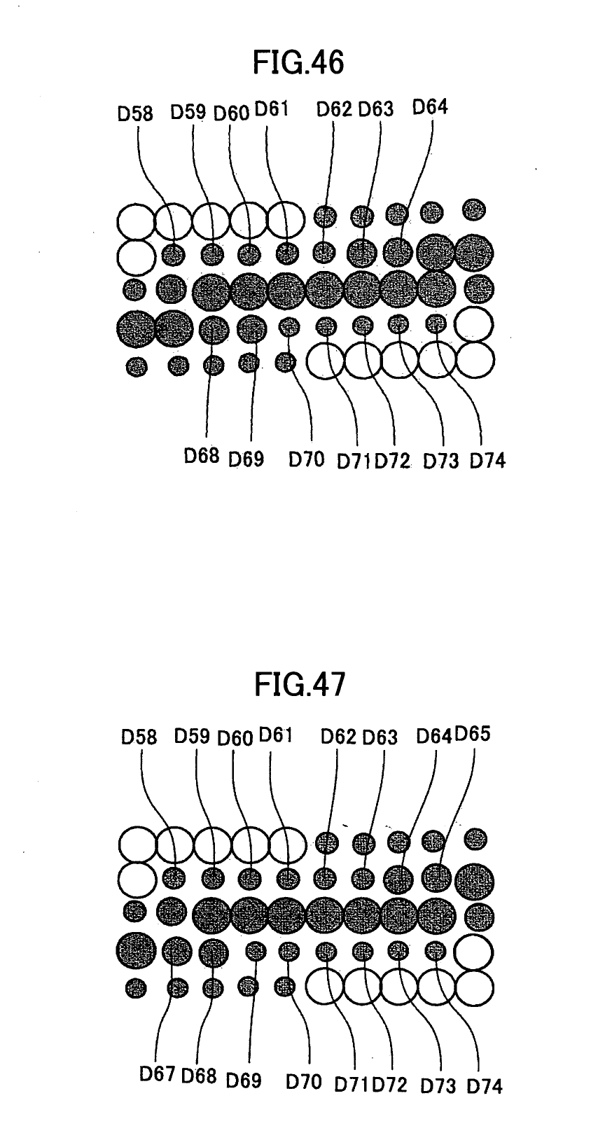

FIG. 46 is a diagram for explaining a character fattening process using a seventh jaggy correction. FIG. 46 shows a case where 4 small image dots are added to 4 blank dots before the transition point at the pixel positions D58 through D61 and D71 through D74, and 2 medium image dots and 1 small image dot replace 3 image dots after the transition point at the pixel positions D63, D64, D68 and D69 for the medium image dots and at the pixel positions D62 and D70 for the small image dots.

FIG. 47 is a diagram for explaining a character fattening process using an eighth jaggy correction. FIG. 47 shows a case where 4 small image dots are added to 4 blank dots before the transition point at the pixel positions D58 through D61 and D71 through D74, and 2 medium image dots and 2 small image dots replace 4 image dots after the transition point at the pixel positions D64, D65, D67 and D68 for the medium image dots and at the pixel positions D62, D63, D69 and D70 for the small image dots.

Therefore, the jaggy correction is carried out with respect to a portion showing a step (or staircase) change, and the character fattening process is carried out with respect to other portions of the character and the adjacent blank background portion, such as the pixel position (dot position) De in FIG. 39A, using the reference pattern shown in FIG. 38A, for example.

The present inventors created characters using the first through eighth jaggy corrections described above, and evaluated the improvement in the readability and recognizability and the inconspicuousness of the jaggy of the created characters. As a result, it was found preferable to add 4 small image dots with respect to 4 blank dots before the transition point and to correct 2 or more image dots forming the character portion, as in the case of the character fattening processes shown in FIGS. 45 through 47.

On the other hand, from the point of view of the processing speed, the character fattening process shown in FIG. 40 has the fastest processing speed, and the processing speed becomes slower for the character fattening processes shown in FIGS. 41 through 47 in this order. One reason for the difference in the processing speeds is that, because the character fattening processes shown in FIGS. 40 through 43 carry out the pattern matching only when the target pixel is the blank dot, but the character fattening processes shown in FIGS. 44 through 47 carry out the pattern matching for all font data, that is, when the target pixel is the blank dot and when the target pixel is the image dot. In other words, it is possible to create the font data in which the jaggy correction is made at a high speed by adding the small image dot only with respect to the blank portion. In addition by replacing only the image dot by the small image dot, it is possible to create the font data in which the jaggy correction is made at a high speed, but this is undesirable when carrying out the character fattening process.

Another reason for the difference in the processing speeds is that, the number of required reference patterns increases for the character fattening processes shown in FIGS. 40 through 47 in this order. For example, a reference pattern is additionally required to judge the second blank dot in addition to the reference patterns required in the character fattening process shown in FIG. 40 when carrying out the character fattening process shown in FIG. 41, a reference pattern is further required to judge the first image dot forming the character portion when carrying out the character fattening process shown in FIG. 44, and a reference pattern is still further required to judge the second image dot forming the character portion when carrying out the character fattening process shown in FIG. 45. Accordingly, the number of reference patterns required for the judgement increases and the number of pattern matchings increases for the character fattening processes shown in FIGS. 40 through 47 in this order.

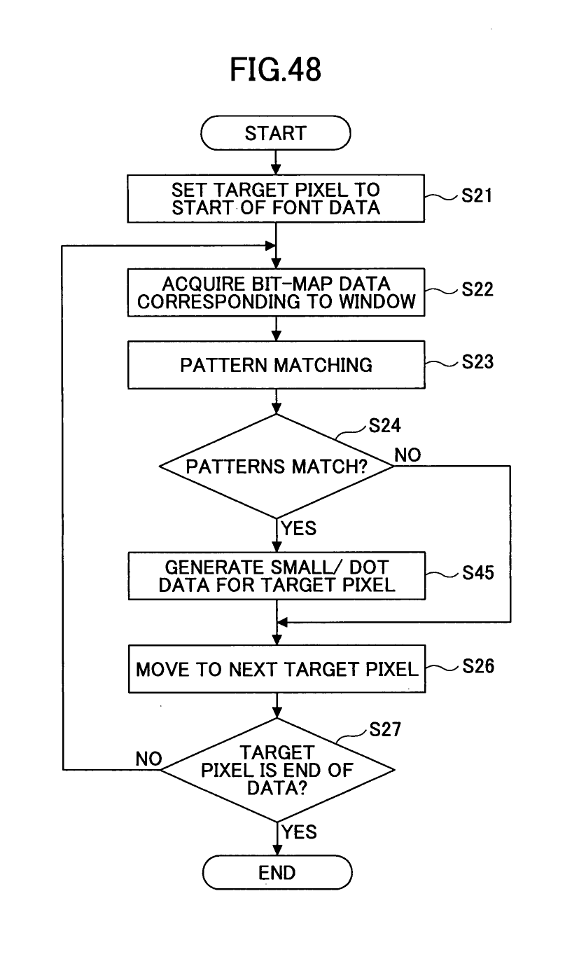

FIG. 48 is a flow chart for explaining the character fattening processes using the fifth through eighth jaggy corrections. In FIG. 48, those steps that are the same as those corresponding steps in FIG. 34 are designated by the same reference numerals, and a description thereof will be omitted. The character fattening process shown in FIG. 48 carries out the pattern matching with respect to both the blank portion and the image portion.

The step S22 acquires the bit-map data of the font data corresponding to the window W, by using the target pixel as the center of the window W. Hence, the acquired bit-map data corresponds to the data amounting to 9×3=27 dots if the window size is 9×3. The step S23 carries out a pattern matching by comparing the acquired bit-map data (pattern of the acquired data) and a predetermined reference data (reference pattern) which is set in advance and is used to add the small or small and medium image dots to the blank dots or to replace the image dots by the medium or medium and small image dots. If the decision result in the step S24 is YES, the step S45 generates the small dot data or, the medium dot data or, the medium dot data and the small dot data for the target pixel, so as to add or replace the dot of the target pixel by the small or medium dot.

The process shown in FIG. 48 may treat one pixel as a 1-byte data or, a 1-bit data. When treating one pixel as a 1-byte data, 27 bytes are required to represent data amounting to 27 dots. On the other hand, when treating one pixel as a 1-bit data, only 4 bytes are required to represent data amounting to 27 dots. Hence, the amount of data to be processed is small when one pixel is treated as a 1-bit data, and the required memory capacity can be reduced and the processing speed can be improved in this case.

In this case, when generating the dot data for the small and medium dots (small and medium ink drops), the print data represented by “0” is changed to “255” representing the image dot data if the original font data is represented by “0” (blank) or “255” (print data) as in the case of the bit-map data, and the changed print data “255” is then replaced by data “185” representing the small dot or data “170” representing the medium dot, for example, and the print data represented by “0” is changed to “1” representing the image dot data if the original font data is represented by “0” (blank) or “1” (print data) as in the case of binary (or bi-level) data, and the changed print data “1” is then replaced by data representing the small dot or data representing the medium dot in a similar manner. Alternatively, when processing the binary data “0” and “1” as they are, a separate memory having the same size as the font data is provided for the print data representing the small dot and for the print data representing the medium dot, and the print data is set to “1” with respect to the pixel position within one separate memory representing the small dot and the print data is set to “1” with respect to the pixel position within the other separate memory representing the medium dot. Therefore, it is possible to fatten the black character and realize oblique lines in which the jaggy is corrected, by recording the font data formed by the data representing the small and medium dots generated by the pattern matching and the data representing the large dots in the first case or, by recording the font data formed by the binary data (“0” and “1”) representing the small dots, the font data formed by the binary data (“0” and “1”) representing the medium dots, and the original binary font data (“0” and “1”) in the latter case.

The font data added to the blank background portion (that is, the dots replacing the blanks of the blank background portion) in the manner described above, and replacing the image portion by the medium dots or medium and small dots where necessary, were printed on plain paper using the ink-jet head under the following conditions, and the picture quality of the character (that is, the character quality) was evaluated.
Head: 384 nozzles/color
   Nozzle pitch=84 μm (corresponding to 300 dpi)
Image Resolution: 600 dpi in the main scanning direction,
   300 dpi in the sub scanning direction
Dot Size Large ink drop=87 μm.
   Medium ink drop=60 μm,
   Small ink drop 40 μm
Character: MS Mincho typeface,
   Font size=6, 10, 12, 20, 30, 50 & 80 points
Jaggy Correction Method: As shown in FIGS. 40 through 47
Printing Method Path number (number of scans forming 1 line)=1, No interlacing
Paper: Plain paper (Type 6200 (product name)) manufactured by Ricoh Company, Ltd.

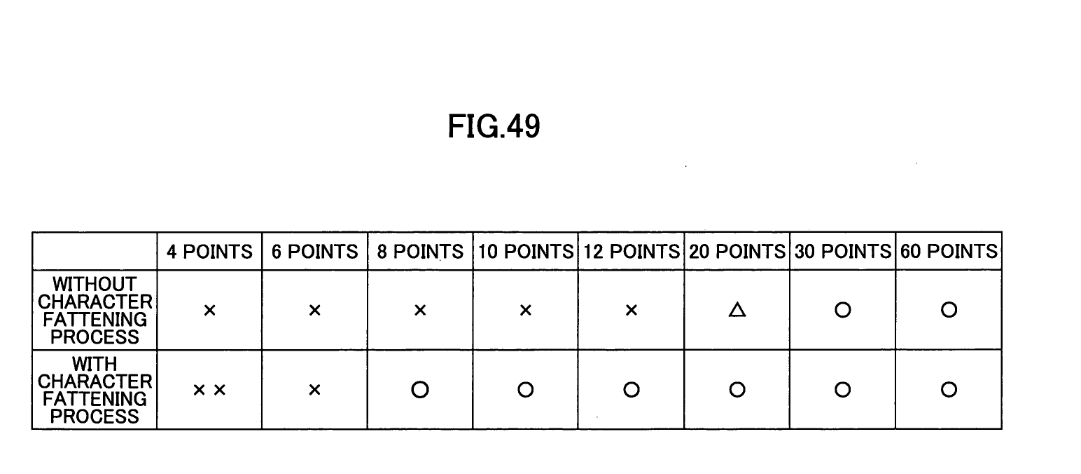

FIG. 49 is a diagram showing evaluation results with and without the character fattening process of this embodiment, for the various character sizes. In FIG. 49, “xx” indicates that the character is deformed and the character quality is extremely poor, “x” indicates that the width (or degree of fatness) of the character is narrow (or thin) and the character quality is poor, “Δ” indicates that the width (or degree of fatness) of the character is slightly narrow (or thin), “o” indicates that the character quality is good and the character is easy to read or recognize.

From the evaluation results shown in FIG. 49, it was confirmed that the character quality is improved, thereby improving the visibility of the character and making the character more easily readable or recognizable by carrying out the character fattening process of this embodiment. Furthermore, it was confirmed that the image tone of the character is sufficiently high and no feathering occurs.

As may be seen from FIG. 49, it was found that the character quality deteriorates if the font size is too small. This is because, in the case of the font size that is too small, the intervals of the dots forming the character are extremely narrow, and the character fattening process would deform the character when the dots are added. It was confirmed that extremely good effects of the character fattening process are obtained when the font size is 8 points or greater.

Although plain paper is used as the recording medium in the description given above, it is also possible to apply the present invention to other recording media such as coated paper, glossy or calendered paper and OHP films, and obtain similar effects. It is also possible to selectively carry out the character fattening process (or not carry out the character fattening process) depending on the kind of recording medium. Hence, it is possible to realize a character having an optimum width (or degree of fatness) depending on the width (or degree of fatness) of the character on the recording medium on which the feathering or bleeding easily occurs and on the recording on which the feathering or bleeding uneasily occurs.

Furthermore, although the characters were printed at 600 dpi in the main scanning direction and 300 dpi in the sub scanning direction (that is, 600 dpi×300 dpi) in the above described case, it is of course possible to obtain similar effects when printing the characters at lower resolutions such as 400 dpi×200 dpi and 300 dpi×150 dpi. The dot diameter of the dots forming the character portion increases as the resolution becomes lower, and the step (or staircase) change becomes more conspicuous. For this reason, the present invention is similarly applicable to cases where the resolution is relatively low, and the effects of the present invention are notable for such relatively low resolutions.

On the other hand, in the case where the resolution is high in both the main and sub scanning directions, such as 600 dpi×600 dpi, 600 dpi×1200 dpi and 1200 dpi×1200 dpi, the number of dots forming the character portion is large, and the dot diameter (or dot size) is small. For this reason, the jaggy is not conspicuous at such high resolutions. Accordingly, in the case of the image forming apparatus having a plurality of printing modes for printing at different resolutions, it is preferable from the point of view of improving the throughput to provide a mode in which the character fattening process is carried out and a normal mode in which no character fattening process is carried out, and to select the one of the two modes depending on the resolution.

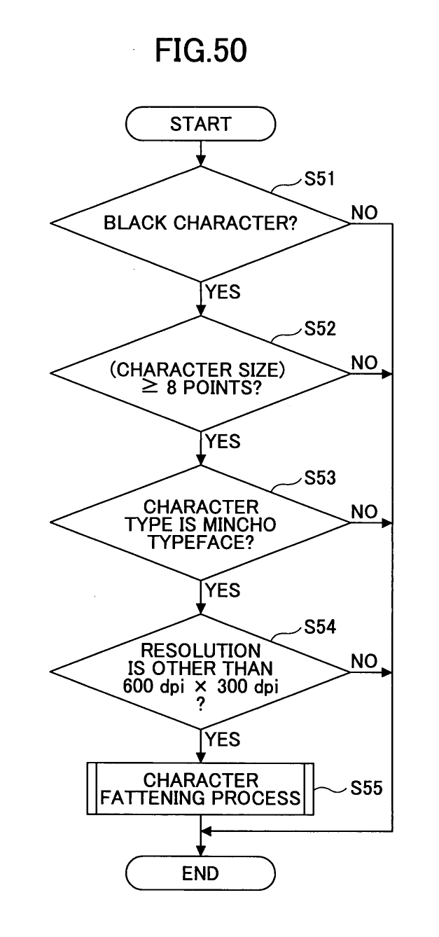

Next, a description will be given of a process which switches between the mode in which the character fattening process is carried out and the normal mode in which no character fattening process is carried out, depending on the character size, the character type and the image resolution, by referring to FIG. 50. FIG. 50 is a flow chart for explaining this process of switching between the mode that carries out the character fattening process depending on the character size, the character type and the image resolution, and the normal mode that does not carry out the character fattening process.

In the process shown in FIG. 50, the character fattening process is carried out when the character size of the white character is 8 points or greater, the character type of the black character is the Mincho typeface, and the image resolution of the black character is 600 dpi×300 dpi or less. Of course, the judging conditions related to the character size, the character type and the image resolution are of course not limited to those shown in FIG. 50.

In FIG. 50, a step S51 decides whether or not the character is a black character. If the decision result in the step S51 is YES, a step S52 decides whether or not the character size is 8 points or greater. If the decision result in the step S52 is YES, a step S53 decides whether or not the character type is the Mincho typeface. If the decision result in the step S53 is YES, a step S54 decides whether or not the image resolution of the character is 600 dpi×300 dpi or lower. If the decision result in the step S54 is YES, a step S55 carries out the character fattening process described above. On the other hand, if the decision result is NO in one of the steps S51 through S54 or, after the step S55, the process ends.

Therefore, by selecting or switching between the mode in which the character fattening process is carried out (mode in which the black dots are added) and the normal mode in which no character fattening process is carried out (mode in which no black dots are added) depending on the character size, the character type and the image resolution, it is possible to obtain a high PPM output without requiring an unnecessarily high processing speed even when obtaining a high throughput.

In addition, by preparing a plurality of kinds of reference patterns depending on the inclination (or slope) of the contour portion of the character, and changing the character fattening process depending on the inclination of the contour portion of the character, it is possible to optimize the character fattening process and obtain a high-quality character. The character fattening process may be changed by changing the position where the image dots are added and/or changing the size of the image dots that are added.

Although the character fattening process is described as fattening the character portion in the description given heretofore, it is of course possible to similarly fatten a graphic image by the character fattening process.

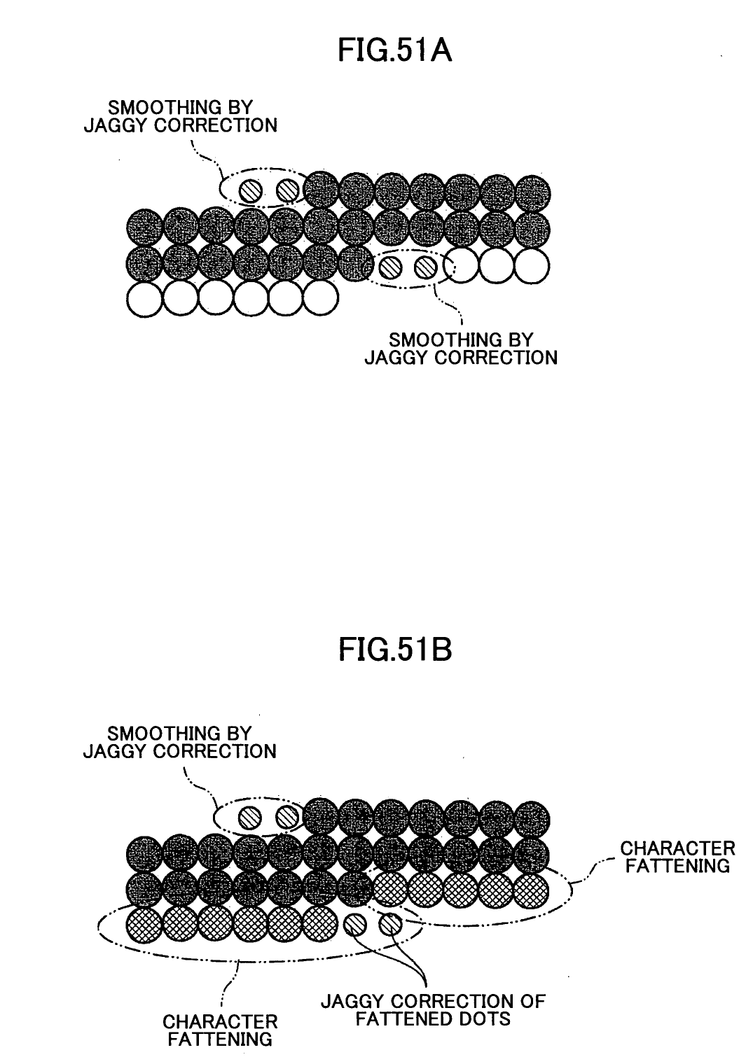

By carrying out the character fattening process which also carries out the jaggy correction or, by carrying out the jaggy correction which also carries out the character fattening process, it is possible to fatten the character and make the character more easily readable and recognizable without greatly deteriorating the processing speed, by simply increasing the number of reference patterns used. FIGS. 51A and 51B are diagrams for explaining the jaggy correction with and without the character fattening process. FIG. 51A shows a case where only the jaggy correction is made, by adding the dots indicated by the hatching to smoothen portion having the step change. On the other hand, FIG. 51B shows a case where the jaggy correction and the character fattening process are carried out, as in the case of this second embodiment. In FIG. 51B, the step change is smoothened by adding the dots indicated by the hatching, and the character portion is fattened by adding the dots indicated by the cross hatching to the portion having no step change.

In the image forming apparatus of this embodiment, the recording head is a piezoelectric head using a piezoelectric element. However, as described above, the recording head may of course be a thermal head which uses an electro-thermal conversion element to eject the ink drop by film boiling. In the case of the piezoelectric head, the ink drops having different sizes can be ejected depending on the driving signal waveform, as described above, and it is possible to easily form a gradation image. On the other hand, in the case of the thermal head, the nozzles can be arranged at a high density, and it is possible to print an image having a high resolution at a high speed.

The different thermal heads described with reference to FIGS. 26A and 26B and FIG. 27 in conjunction with the first embodiment are similarly usable in this second embodiment.

Therefore, this second embodiment carries out the character fattening process with respect to the black character, while the first embodiment described above carries out the character fattening process with respect to the white character.

This application claims the benefit of Japanese Patent Applications No. 2005-321550 filed Nov. 4, 2005 and No. 2005-321621 filed Nov. 4, 2005, in the Japanese Patent Office, the disclosures of which are hereby incorporated by reference.

Further, the present invention is not limited to these embodiments, but various variations and modifications may be made without departing from the scope of the present invention.

1. An image processing method for generating image data for use by an image forming apparatus which forms an image on a recording medium by ink dots formed by ejected ink drops, comprising:
judging an image portion and a background portion of the image; and
adding image dots to the background portion adjacent to the image portion to fatten the image portion by a fattening process, depending on at least one of a character size of the image portion, a character type of the image portion, a resolution of the image portion, and a color of the background portion.

2. The image processing method as claimed in claim 1, wherein pixel positions where the image dots are added to the background portion are determined by carrying out a pattern matching between a window having a predetermined size and including a target pixel and reference patterns having the predetermined size, by moving the window relative to the image.

3. The image processing method as claimed in claim 2, wherein the image dots are blank dots forming the image portion, the background portion are formed by the ink dots, and the target pixel is a blank dot.

4. The image processing method as claimed in claim 3, wherein the image dots that are added to the background portion have a size identical to the image dots forming the image portion.

5. The image processing method as claimed in claim 2, wherein the image dots are ink dots forming the image portion, the background portion are formed by the blank dots, and the target pixel is an ink dot or a blank dot.

6. The image processing method as claimed in claim 5, comprising:
replacing image dots of the image portion by an image dot having a different size, in a vicinity of a boundary between the image portion and the background portion, by a jaggy correction.

7. The image processing method as claimed in claim 5, wherein the image dots that are added to the background portion or, the image dots that replace the image dots of the image portion, have a size smaller than the image dots forming the image portion and include one or a plurality of different sizes.

8-9. (canceled)

10. An image processing apparatus comprising:
a control part configured to generate image data for use by an image forming apparatus which forms an image on a recording medium by ink dots formed by ejected ink drops,
wherein the control part comprises:
a part configured to judge an image portion and a background portion of the image; and
a part configured to add image dots to the background portion adjacent to the image portion to fatten the image portion by a fattening process only during a predetermined mode.

11. The image processing apparatus as claimed in claim 10, wherein an operation mode is switched to the predetermined mode depending on at least one of a character size of the image portion, a character type of the image portion, a resolution of the image portion, and a color of the background portion.

12. The image processing apparatus as claimed in claim 11, wherein pixel positions where the image dots are added to the background portion are determined by carrying out a pattern matching between a window having a predetermined size and including a target pixel and reference patterns having the predetermined size, by moving the window relative to the image.

13. The image processing apparatus as claimed in claim 12, wherein the image dots are blank dots forming the image portion, the background portion are formed by the ink dots, and the target pixel is a blank dot.

14. The image processing apparatus as claimed in claim 13, wherein the image dots that are added to the background portion have a size identical to the image dots forming the image portion.

15. The image processing apparatus as claimed in claim 12, wherein the image dots are ink dots forming the image portion, the background portion are formed by the blank dots, and the target pixel is an ink dot or a blank dot.

16. The image processing apparatus as claimed in claim 15, wherein the control part comprises a part configured to replace image dots of the image portion by an image dot having a different size, in a vicinity of a boundary between the image portion and the background portion, by a jaggy correction.

17. The image forming processing apparatus as claimed in claim 15, wherein the image dots that are added to the background portion or, the image dots that replace the image dots of the image portion, have a size smaller than the image dots forming the image portion and include one or a plurality of different sizes.

18. A computer-readable program for causing a computer to generate image data for use by an image forming apparatus which forms an image on a recording medium by ink dots formed by ejected ink drops, comprising:
a procedure causing the computer to judge an image portion and a background portion of the image; and
a procedure causing the computer to add image dots to the background portion adjacent to the image portion to fatten the image portion by a fattening process, depending on at least one of a character size of the image portion, a character type of the image portion, a resolution of the image portion, and a color of the background portion.

19. The computer-readable program as claimed in claim 18, wherein the image dots are blank dots forming the image portion, the background portion are formed by the ink dots, and the target pixel is a blank dot.

20. The computer-readable program as claimed in claim 18, wherein the image dots are ink dots forming the image portion, the background portion are formed by the blank dots, and the target pixel is an ink dot or a blank dot.

21. The computer-readable program as claimed in claim 18 that is stored in a computer-readable storage medium.
